(19) United States
(12) Patent Application Publication
(10) Pub. No.: US 2026/0182544 A1
(43) Pub. Date: Jul. 2, 2026

(54) QUANTITATIVE PREDICTION METHOD AND DEVICE FOR CHANGES IN SPATIOTEMPORAL DISTRIBUTION OF VOLE POPULATIONS

(71) Applicant: Chinese Research Academy of Environmental Sciences, Beijing (CN)

(72) Inventors: Guoxian Huang, Beijing (CN); Meiwen Zhang, Beijing (CN); Qiuwen Chen, Beijing (CN); Qianqian Zhang, Beijing (CN); Pinfeng Jiang, Beijing (CN); Xingding Liao, Beijing (CN); Xiang Wang, Beijing (CN); Shilin Ge, Beijing (CN); Da Zhang, Beijing (CN)

(21) Appl. No.: 19/432,293

(22) Filed: Dec. 24, 2025

(30) Foreign Application Priority Data
Dec. 30, 2024 (CN) 2024119669961

(51) Int. Cl. A01K 29/00

(52) U.S. Cl. CPC A01K 29/005; A01K 2227/105

(57) ABSTRACT

A quantitative prediction method for changes in spatiotemporal distribution of vole populations includes: determining a habitat of voles based on an activity range of the voles; dividing the habitat of voles into an unstructured grid with triangular units as basis; constructing a quality evaluation model for the habitat of voles, a migration model for vole subpopulations, a size change model for the vole populations, and an energy storage change model of the voles; performing coupled computation on the quality evaluation model for the habitat of voles, the migration model for the vole subpopulations, the size change model for the vole populations, and the energy storage change model of the voles to obtain computation results; and predicting the changes in the spatiotemporal distribution of the vole populations based on the computation results.

### CROSS-REFERENCE TO RELATED APPLICATION

This application claims priority to Chinese Patent Application No. 202411966996.1, filed on Dec. 30, 2024, which is herein incorporated by reference in its entirety.

### TECHNICAL FIELD

The disclosure relates to the technical field of species distribution prediction in ecological environments, and more particularly to a quantitative prediction method and device for changes in spatiotemporal distribution of vole populations.

### BACKGROUND

A region surrounding the Dongting Lake has flat terrain and abundant water resources, making it an important grain-producing region in China. However, this region frequently suffers from rodent disasters dominated by reed voles (also referred to as Microtus fortis). Population changes of the reed voles are primarily influenced by factors including growth and reproductive characteristics of vole populations themselves, an area and changes of a habitat, an initial population size, composition and changes in food sources available to the reed voles, changes in populations of major predatory animals, migration of the vole populations, and human interference through rodent control measures.

To control reproduction of voles, researchers have proposed a dynamics model of the vole populations and coupled the dynamics model of the vole populations with a one-dimensional mixed river network unsteady flow-sediment model for the region surrounding the Dongting Lake. Supported by survey data on densities and migration behavior of the voles and regional digital elevation model (DEM) data, the researchers quantitatively study changes in habitats, population sizes, and spatial distributions of the voles under influence of various factors (with a focus on changes in flow-sediment conditions caused by reservoir scheduling and reclamation of sandbanks), to thereby provide a scientific basis for effectively controlling rodent disasters. Research on the voles in sandbanks of the Dongting Lake has already established a certain foundation, mainly including individual development, reproductive processes and their main influencing factors, surveys on the vole populations, changes in habitat, composition and changes of food chains, migration processes, mechanisms of the rodent disasters, and loss surveys. Research methods mainly involve indoor observation, individual dissection, field observation and survey, and statistical and dynamic model simulation.

Research and surveys have fully shown that reed vole disaster in the Dongting Lake is severe, and development of vole populations is closely related to individual characteristics, distribution of the habitat, and changes in the habitat. Studies in the art have established a certain foundation for growth, reproduction, and habitats of the reed voles in the Dongting Lake region. However, research on dynamic models for populations is scarce, making it impossible to make accurate prediction on changes in distribution of the vole populations.

### SUMMARY

To solve an issue that research on dynamic models of reed vole populations is scarce, making it difficult to quantitatively analyze mechanisms of hydrodynamic conditions and geomorphological changes affecting dynamics of the reed vole populations, and thus preventing proposal of corresponding flow discharge regulation measures, the disclosure provides a quantitative prediction method and device for changes in spatiotemporal distribution of vole populations.

To achieve the aforementioned objectives, the disclosure provides the following technical solutions.

The quantitative prediction method for the changes in the spatiotemporal distribution of the vole populations includes the following steps:
determining a habitat of voles based on an activity range of the voles, and dividing the habitat of voles into an unstructured grid with triangular units as basis;
determining environmental change parameters of the habitat of voles and a density of the voles as reference factors, calculating a spatiotemporal change result of each of the reference factors, and establishing, based on the spatiotemporal change result of each of the reference factors, a quality evaluation model for the habitat of voles using a geometric mean method;
grouping the voles in each of grid units of the unstructured grid according to ages and genders to obtain grouping results as vole subpopulations; constructing, based on the grouping results, a migration model with age and sex structure for the vole subpopulations; and constructing a size change model for the vole populations based on a number of the vole subpopulations in the grid units of the unstructured grid, mortality rates of the vole subpopulations, and a population size control equation;
solving for energy input, energy output, a migration energy consumption rate, a growth energy consumption rate, a pregnancy additional energy consumption rate, and a nurturing additional energy consumption rate of the voles within the grid units of the unstructured grid to obtain solved results; and constructing, based on the solved results and an energy balance accounting equation, an energy storage change model of the voles at each time step; and
performing coupled computation on the quality evaluation model for the habitat of voles, the migration model for the vole subpopulations, the size change model for the vole populations, and the energy storage change model of the voles to obtain numerical values of changes in sizes of the vole populations in different grid units of the unstructured grid, and predicting the changes in the spatiotemporal distribution of the vole populations based on the numerical values of the changes in the sizes of the vole populations.

In an embodiment, after obtaining prediction results of the changes in the spatiotemporal distribution of the vole populations, anticoagulant rodenticides (such as bromadiolone) or physical measures (such as physical trap setting) can be used in regions where the voles are densely concentrated or on key migration paths of the voles respectively during water level rising period. Farmers can, based on the prediction results, adjust sowing or harvesting time of crops at some degree to avoid peak activity period of the voles, switch to crops less attractive to voles (such as replacing alfalfa with corn) in regions prone to dense concentration of the voles, or implement crop rotation or intercropping strategies to disrupt food chain dependence of the voles. Moreover, during a breeding period of the voles, discharge operation of Three Gorge Reservoirs can be increased to increase a mortality rate of new born voles, thereby decreasing the sizes of the vole populations.

In an embodiment, quality of the habitat of voles is scored through the quality evaluation model for the habitat of voles according to the following formula:

$${Scor}_{ie}^{t} = {( \begin{matrix}{SSoilT}_{ie} \cdot {SPlantT}_{ie} \cdot {SLandU}_{ie}^{t} \cdot {SInund}_{ie}^{t} \cdot \\ {ScDens}_{ie}^{t} \cdot {SRs}_{ie}^{t} \cdot {ST}_{ie}^{t} \cdot {SMois}_{ie}^{t} \cdot {SEnem}_{ie}^{t}\end{matrix} )}^{\frac{1}{{n}^{′}}}$$

where

$${Scor}_{ie}^{t}$$

represents a quality score of the habitat of voles at a time t in an ie-th grid unit of the unstructured grid, n′ represents a number of the reference factors, SSoilTᵢₑ represents a scoring for different soil types, SPlantTᵢₑ represents a scoring for a vegetation type,

$${SLandU}_{ie}^{t}$$

represents a scoring for land use,

$${SInund}_{ie}^{t}$$

represents a scoring for water inundation,

$${ScDens}_{ie}^{t}$$

represents a correlation scoring of the density of the voles,

$${SRs}_{ie}^{t}$$

represents a scoring for water depth of the habitat of voles,

$${ST}_{ie}^{t}$$

represents a scoring for a ground temperature of the habitat of voles,

$${SMois}_{ie}^{t}$$

represents a scoring for a soil moisture content, and

$${SEnem}_{ie}^{t}$$

represents a scoring tor natural enemies in the habitat of voles.

In an embodiment, formulas of the migration model for the vole subpopulations are expressed as follows:

$${X}_{ie , jgd , kag}^{n + 1} = {X}_{ie , jgd , kag}^{n} + ( {U}_{flow} + α \cdot {U}_{Max , jgd , kag} \cdot sin θ + \frac{\partial {D}_{x}}{\partial x} ) Δ t + R \sqrt{6 \cdot {D}_{x}^{*} \cdot Δ t} ;$$

$${Y}_{ie , jgd , kag}^{n + 1} = {Y}_{ie , jgd , kag}^{n} + ( {V}_{flow} + α \cdot {U}_{Max , jgd , kag} \cdot cos θ + \frac{\partial {D}_{y}}{\partial y} ) Δ t + R \sqrt{6 \cdot {D}_{y}^{*} \cdot Δ t} ;$$

$$where , {X}_{ie , jgd , kag}^{n + 1} and {Y}_{ie , jgd , kag}^{n + 1}$$

represent grid coordinates of a specific position of a kag-th age and jgd-th gender group of the vole subpopulations at locations x and y at an (n+1)-th time step, respectively;

$${X}_{ie , jgd , kag}^{n} and {Y}_{ie , jgd , kag}^{n}$$

represent grid coordinates of the specific position of the kag-th age and jgd-th gender group of the vole subpopulations at the locations x and y at an n-th time step, respectively; U_{flow} and V_{flow} respectively represent water flow velocities in an x direction and a y direction; U_{Max,jgd,kag} represents a maximum migration speed of the kag-th age and jgd-th gender group of the vole subpopulations; θ represents an included angle between a migration target grid unit and a source grid unit; α represents a speed correction coefficient; Dₓ and D_{y} represents turbulence coefficients of water flow in the x direction and the y direction, respectively; n represents a last time step, * represents an (n+½)-th time step, (n+1) represents a current time step, Δt represents a time step length, and R represents a random time constant.

In an embodiment, when ages of the voles are larger than 20 days, the formula of the size change model for the vole populations is expressed as follows:

$${P}_{ie , jgd , kag}^{n + 1} = {Psk}_{ie , jgd , kag}^{n} \cdot ( 1 - {Dsk}_{ie , jgd , kag} ) + {\sum }_{nm = 1}^{Num ( ie , jgd , kag )} {Pmv}_{ie , jgd , kag , nm} \cdot ( 1 - {Dmv}_{ie , jgd , kag , nm} ) ;$$

$$where , {P}_{ie , jgd , kag}^{n + 1}$$

represents a number of voles in the kag-th age and jgd-th gender group of the vole subpopulations in the ie-th grid unit at the (n+1)-th time step,

$${Psk}_{ie , jgd , kag}^{n}$$

represents a number of voles in the kag-th age and jgd-th gender group of the vole subpopulations in the ie-th grid unit at the n-th time step, Pmv_{ie,jgd,kag,nm} represents a number of voles that migrate from all grid units adjacent to the ie-th grid unit to the kag-th age and jgd-th gender group of the vole subpopulations in the ie-th grid unit within a time step length from the n-th time step to the (n+1)-th time step, Num(ie,jgd,kag) represents a number of vole subpopulations that migrate to the ie-th grid unit having a same age and a same gender; Dsk_{ie,jgd,kag} represents a mortality rate of the voles in the kag-th age and jgd-th gender group of the vole subpopulations in a static stack area of the ie-th grid unit, and Dmv_{ie,jgd,kag,nm} represents a mortality rate of the voles that migrate from all the grid units adjacent to the ie-th grid unit to the kag-th age and jgd-th gender group of the vole subpopulations in the migration target grid unit of the ie-th grid unit;
when the ages of the voles are less than 20 days and the number of the voles that migrate to the kag-th age and jgd-th gender group of the vole subpopulations in the ie-th grid unit is not taken into account, the formula for calculating the

$${P}_{ie , jgd , kag}^{n + 1}$$

is expressed as follows:

$${P}_{ie , jgd , kag}^{n + 1} = {Psk}_{ie , jgd , kag}^{n} \cdot ( 1 - {Dsk}_{ie , jgd , kag} ) + Δ {P}_{igd}^{n + 1} \cdot {( 1 - {Dsk}_{ie , jgd , kag} )}^{Mod ( n , \frac{86400 \times 20}{Δ t} )} ;$$

$$Δ {P}_{igd}^{n + 1} = {\sum }_{kag = 1}^{Maxag} {P}_{1 , kag}^{n} \cdot {Rpreg}_{kag} \cdot {B}_{kag} \cdot {R}_{jgd} ;$$

$$where {P}_{1 , kag}^{n}$$

represents a total number of mature female reed voles within the time step length from the n-th time step to the (n+1)-th time step, Rpreg_{kag} represents a pregnancy rate of the voles, B_{kag} represents an average litter size, and R_{jgd} represents a gender ratio of newborn voles;
when the ages of the voles are larger than 10 days but less than 20 days and the number of the voles that migrate to the kag-th age and jgd-th gender group of the vole subpopulations in the ie-th grid unit is not taken into account, the formula for calculating the

$${P}_{ie , jgd , kag}^{n + 1}$$

is expressed as follows:

$${P}_{ie , jgd , kag}^{n + 1} = {Psk}_{ie , jgd , kag}^{n} \cdot ( 1 - {Dsk}_{ie , jgd , kag} ) .$$

In an embodiment, a formula of the energy storage change model of the voles is expressed as follows:

$${E}_{sk , ie , jgd , kag}^{n + 1} = {E}_{sk , ie , jgd , kag}^{n} + {EIn}_{ie , jgd , kag} - {Mb}_{ie , jgd , kag} \cdot Δ t - {EMov}_{ie , jgd , kag} - {EAdd}_{ie , jgd , kag} ;$$

$$where {E}_{sk , ie , jgd , kag}^{n + 1} and {E}_{sk , ie , jgd , kag}^{n}$$

represent energy values of the kag-th age and jgd-th gender group of the vole subpopulations living in the ie-th grid unit at the (n+1)-th time step and the n-th time step, respectively, EIn_{ie,jgd,kag} represents an energy supply obtained by the voles in the kag-th age and jgd-th gender group of the vole subpopulations living in the ie-th grid unit within the time step length Δt, Mb_{ie,jgd,kag} represents an energy consumption rate due to basal metabolism of the kag-th age and jgd-th gender group of the vole subpopulations living in the ie-th grid unit, EMov_{ie,jgd,kag} represents energy consumed by the kag-th age and jgd-th gender group of the vole subpopulations living in the ie-th grid unit during migration in the time step length Δt, and EAdd_{ie,jgd,kag} represents additional energy consumed by the kag-th age and jgd-th gender group of the vole subpopulations living in the ie-th grid unit in digging burrows and nurturing young within the time step length Δt, and Δt represents the time step length.

The disclosure further provides the quantitative prediction device for the changes in the spatiotemporal distribution of the vole populations, including:
a habitat division module, configured to determine the habitat of voles based on the activity range of the voles and divide the habitat of voles into the unstructured grid with the triangular units as the basis;
a first model construction module, configured to determine the environmental change parameters of the habitat of voles and the density of the voles as the reference factors, calculate the spatiotemporal change result of each of the reference factors, and establish the quality evaluation model for the habitat of voles using the geometric mean method based on the spatiotemporal change result of each of the reference factors;
a second model construction module, configured to group the voles in each of the grid units of the unstructured grid according to the ages and the genders to obtain the grouping results as the vole subpopulations, construct, based on the grouping results, the migration model with the age and gender structure for the vole subpopulations; and construct the size change model for the vole populations based on the number of the vole subpopulations in the grid units of the unstructured grid, the mortality rates of the vole subpopulations, and the population size control equation;
a third model construction module, configured to solve for the energy input, the energy output, the migration energy consumption rate, the growth energy consumption rate, the pregnancy additional energy consumption rate, and the nurturing additional energy consumption rate of the voles within the grid units of the unstructured grid to obtain the solved results and construct, based on the solved results and the energy balance accounting equation, the energy storage change model of the voles at each time step; and
a prediction module, configured to perform the coupled computation on the quality evaluation model for the habitat of voles, the migration model for the vole subpopulations, the size change model for the vole populations, and the energy storage change model of the voles to obtain the numerical values of changes in the sizes of the vole populations in different grid units of the unstructured grid and predict the changes in the spatiotemporal distribution of the vole populations based on the numerical values of changes in the sizes of vole populations.

The disclosure further provides a computer device, including a memory and a processor. The memory is stored with a computer-executed instruction. The processor is configured to execute the computer-executed instruction stored in the memory, to thereby implement steps of the quantitative prediction method for the changes in the spatiotemporal distribution of the vole populations as described above.

The disclosure further another provides a computer-readable storage medium configured to store a computer-executed instruction. The computer-executed instruction, when executed by a processor, is used to implement the steps of the quantitative prediction method for the changes in the spatiotemporal distribution of the vole populations as described above.

The quantitative prediction method for the changes in the spatiotemporal distribution of the vole populations provided by the disclosure has the following beneficial effects.

The disclosure firstly divides the habitat of voles into the unstructured grid to facilitate construction of models. On this basis, the environmental change parameters of the habitat of voles, the density of the voles, the ages of the voles, the genders of the voles, and associated energy consumption rates of the voles in the grid units of the unstructured grid are combined to construct the quality evaluation model for the habitat of voles, the migration model for the vole subpopulations, the size change model for the vole populations, and the energy storage change model of the voles, respectively. The construction of these models combines the environmental change parameters of the habitat of voles and individual characteristics of the voles. Through these models, dynamic values such as the changes in the sizes of the vole populations can be obtained. On a basis of the unstructured grid, coupling the above four models according to prediction requirements can accurately predict a change range of the spatiotemporal distribution of the vole populations based on computation results, which is of great significance to effectively control outbreaks of rodent disasters.

### BRIEF DESCRIPTION OF DRAWINGS

In order to explain embodiments of the disclosure and design schemes therefor more clearly, attached drawings required for the embodiments will be briefly introduced below. The attached drawings in the following description are only a part of the embodiments of the disclosure, and for those skilled in the art, other attached drawings can be obtained according to these drawings without creative work.

FIG. 1 illustrates a flowchart of a quantitative prediction method for changes in spatiotemporal distribution of vole populations according to an embodiment of the disclosure.

FIG. 2 illustrates a field survey route map for the Dongting Lake.

FIG. 3 illustrates a schematic framework of principles of a model of the quantitative prediction method according to embodiment 1 of the disclosure.

FIG. 4 illustrates an overall schematic diagram of a computation area of the model of the quantitative prediction method according to embodiment 1 of the disclosure, where (a) illustrates the computation area of the model of the quantitative prediction method, and (b) illustrates a local distribution diagram of an unstructured grid.

FIG. 5 illustrates a body weight diagram and a migration speed diagram in water and on land of reed voles of different ages according to embodiment 1 of the disclosure, where (a) illustrates weight distribution curves of the reed voles of different ages, and (b) illustrates migration speed distribution curves of the reed voles in water and on land.

FIG. 6 illustrates an energy consumption diagram of the vole populations according to embodiment 1 of the disclosure.

FIG. 7 illustrates test result diagrams of the model of the quantitative prediction method in habitats of voles in lake beaches and farmlands in Yueyang City according to embodiment 1 of the disclosure.

FIG. 8 illustrates validation result diagrams of the model of the quantitative prediction method on densities of voles at four sites according to embodiment 1 of the disclosure.

FIG. 9 illustrates prediction result diagrams of flood inundation, soil moisture content, habitat score, and density distribution of the voles in the computation area on Jan. 1, 2007, according to embodiment 1 of the disclosure.

FIG. 10 illustrates prediction result diagrams of flood inundation, soil moisture content, habitat score, and density distribution of the voles in the computation area on Jun. 1, 2007, according to embodiment 1 of the disclosure.

FIG. 11 illustrates prediction result diagrams of flood inundation, soil moisture content, habitat score, and density distribution of the voles in the computation area on Jul. 31, 2007, according to embodiment 1 of the disclosure.

FIG. 12 illustrates prediction result diagrams of flood inundation, soil moisture content, habitat score, and density distribution of the voles in the computation area on Nov. 8, 2007, according to embodiment 1 of the disclosure.

FIG. 13 illustrates computation result diagrams of environmental factors and changes of reed vole populations in a region surrounding the Dongting Lake from 1990 to 2011, according to embodiment 1 of the disclosure, where (a) illustrates variation curves of temperature and average precipitation of the computation area at 14 sites, (b) illustrates a daily average measured water level change curve of Chenglingji, (c) illustrates a temporal variation of predicted environmental carrying capacity in Dongting lake region, a total population of the voles in the Dongting Lake region and a region within 10 kilometers (km) outside an embankment of the Dongting Lake, the vole populations at farmlands outside the embankment of the Dongting Lake, and a female ratio at the computation area, and (d) illustrates a temporal variation of predicted energy storage saturation in bodies of the voles in the Dongting Lake region and the region within 10 km outside the embankment of the Dongting Lake.

FIG. 14 illustrates a computation distribution diagram of age structures of the vole populations in the lake beaches and the farmlands outside the embankment computed using a graph model from 1991 to 2011 according to embodiment 1 of the disclosure.

### DETAILED DESCRIPTION OF EMBODIMENTS

To make those skilled in the art better understand and implement technical solutions of the disclosure, the disclosure will be described in detail with reference to attached drawings and embodiments. Embodiments described below are only used to more clearly illustrate the technical solutions of the disclosure and should not be considered as limiting a scope of protection of the disclosure.

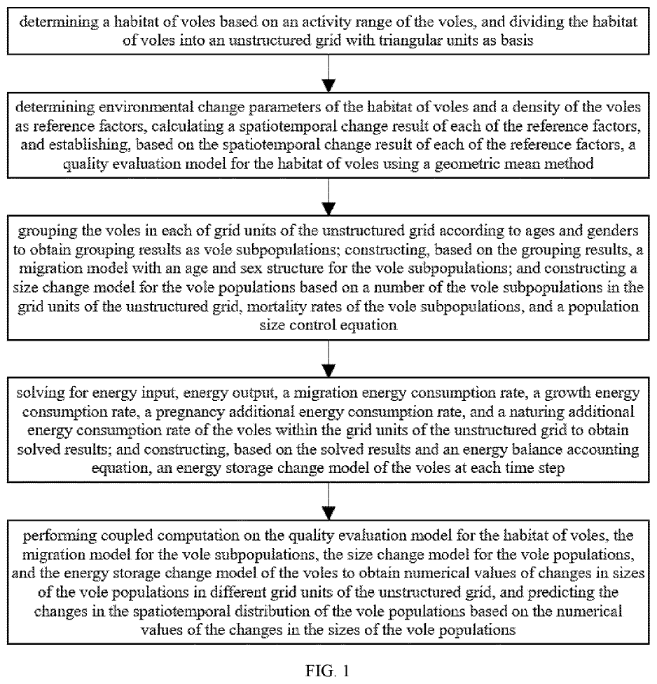

A quantitative prediction method for changes in spatiotemporal distribution of vole populations provided by the disclosure, as illustrated in FIG. 1, includes the following steps S1 through S6.
S1, a habitat of voles is determined based on an activity range of voles. The habitat of voles mainly includes wetlands in lake regions, beaches, and farmland areas outside embankments.
S2, the habitat of voles is divided into an unstructured grid with triangular units as basis. Lakes, islands, the embankments, and their boundaries with the farmlands are effectively distinguished.
S3, soil types, vegetation types, land use types, precipitation, flood inundation status, soil moisture content, and a density of the voles are determined as reference factors. A spatiotemporal change result of each of the reference factors is calculated through coupling a distributed hydrological model, a hydrodynamic model, and a biological population model. A quality evaluation model of the habitat for voles is constructed using a geometric mean method based on the spatiotemporal change result of each of the reference factors.
S4, the voles in each of grid units of the unstructured grid are grouped according to ages and genders to obtain grouping results as vole subpopulations. A migration model with an age and gender structure for the vole subpopulations is constructed by combining the grouping results with key parameter survey data of mass conservation, energy accounting conservation, migration direction judgment, biological reproduction, and behavior. At the same time, during a solving process, by effectively combining flow velocities, water depths, and turbulence coefficients of water flow calculated by a regional hydrodynamic model with a quality score of the habitat of voles calculated by the quality evaluation model for the habitat of voles, migration decisions and determinations are made. A size change model for the vole populations is constructed based on a number of the vole sub-populations in the grid units of the unstructured grid, mortality rates of the vole subpopulations, and a population size control equation.
S5, energy input, energy output, a migration energy consumption rate, a growth energy consumption rate, a pregnancy additional energy consumption rate, and a nurturing additional energy consumption rate of the voles within the grid units of the unstructured grid are solved out to obtain solved results. An energy storage change model of the voles at each time step is constructed based on the solved results and an energy balance accounting equation.
S6, the quality evaluation model for the habitat of voles, the migration model for the vole subpopulations, the size change model for the vole populations, and the energy storage change model of the voles are performed with different coupled computations to obtain densities of the voles in different grid units of the unstructured grid. Changes in the spatiotemporal distribution of the vole populations are predicted based on the densities of the voles in different grid units of the unstructured grid.

### Embodiment 1

In the following, taking the Dongting Lake as an example, the quantitative prediction method for the changes in the spatiotemporal distribution of the vole populations provided by the disclosure is used to predict changes in spatiotemporal distribution of reed vole populations living in a region surrounding the Dongting Lake. A dynamic evaluation model considering multiple factors for scoring quality of the habitat of voles in the region surrounding the Dongting Lake, a migration model for the vole populations with different ages and genders, a distributed hydrological model for wetlands in lake region, and a two-dimensional hydrodynamic model of the lake region based on a semi-implicit Eulerian-Lagrangian finite-element (SELFE) model developed by Yinglong Zhang and António M. Baptista (2008). These models are coupled at different levels for computation, and a variation process of the reed vole populations in the Dongting Lake over multiple years is reconstructed through model computation.

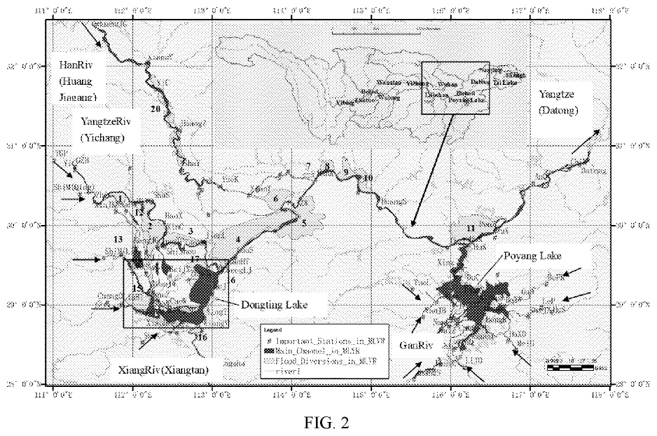

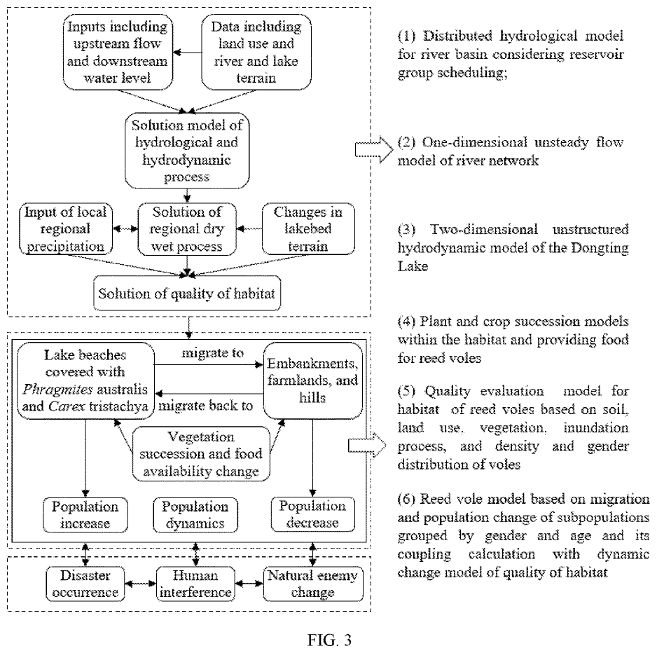

A framework for a reed vole population model is constructed. Key parameters required by the reed vole population model are obtained through historical data collection and field surveys. Population changes of the reed voles are closely related to flood inundation, population density changes, reservoir group scheduling, changes in natural enemies, and migration behavior of the reed voles. Main mechanisms, influencing factors, and a flowchart of a model that needs to be adopted or established in this study are illustrated in FIG. 3. Through quarterly (with monthly surveys during high-density periods of the voles) on-site field surveys of the reed voles living in the region surrounding the Dongting Lake (a survey area is illustrated in FIG. 2), population dynamics monitoring, parameter extraction of voles, and visiting a reed vole indoor breeding laboratory of an agricultural research institute, historical data from field surveys and indoor breeding data of the reed voles are collected. Based on remote sensing images, soil, vegetation, and land use information in a study region are interpreted and extracted by using software such as ArcGIS. Furthermore, based on relevant literature, survey data, and experimental results, maximum habitat density, birth rates, mortality rates, and habitat quality evaluation scores of the reed voles under different soil and vegetation conditions are obtained. These parameters are specifically shown in tables 1 and 2 below. By analyzing the historical data from filed surveys, the indoor breeding data, and the relevant literature, parameters of the reed voles, including growth curves, reproductive parameters, mortality rates, and migration speeds, are summarized (see FIG. 5) and actually used for calibration of necessary parameters the model.

TABLE 1
basic living parameters of reed voles under different soil conditions

| | | | Unit weight | | | |
|---|---|---|---|---|---|---|
| | | Thickness | (grams per cubic | | | |
| | | (centimeter, | centimeter, | | | |
| | Score | abbreviated | abbreviated | | | Geomorphic |
| Name | (0-1) | as cm) | as g/cm³) | Porosity | Texture | unit |
| Alluvial Soil | 0.60 | 90 | 2.650 | 1.300 | Granular | Lake |
| Calcareous Sand | 1.00 | 62 | 2.000 | 1.100 | Granular | Lake beach |
| Lake clayey Soil | 0.60 | 50 | 1.900 | 1.140 | Cloudy | Paddy field |
| Bog Soils | 0.80 | 100 | 1.800 | 1.200 | Block | Swamp |
| Purplish Soils | 0.70 | 45 | 2.600 | 0.900 | Block | Mounds |

TABLE 2
life and reproductive parameters of the reed voles under different land use types

| | | MaxDens | | | | | |
|---|---|---|---|---|---|---|---|
| | | (individual per | | | | | |
| | | square meter, | | Baby | Birth | | |
| | Score | abbreviated as | Pregnancy | Birth | Rate | ♂Mortality | ♀Mortality |
| NamEg | (0-1) | Ind./m²) | (%) | (Ind.) | (%/d) | Rate (%/d) | Rate (%/d) |
| Water | 0.010 | 0.001 | 10.00 | 1.00 | 0.00 | 2.75 | 4.26 |
| Aquatic_Veg | 0.500 | 0.083 | 35.00 | 4.38 | 0.80 | 1.02 | 1.57 |
| SandBeach | 0.600 | 0.751 | 45.00 | 4.38 | 3.90 | 0.39 | 0.61 |
| Carex | 0.950 | 0.450 | 51.40 | 5.06 | 4.20 | 0.31 | 0.49 |
| Carex_Phragmites | 1.000 | 0.500 | 51.40 | 5.06 | 6.50 | 0.20 | 0.30 |
| Phragmites_Communis | 0.950 | 0.350 | 51.40 | 5.06 | 3.90 | 0.26 | 0.40 |
| WetFarmland | 0.500 | 0.029 | 20.40 | 5.37 | 0.50 | 1.18 | 1.82 |
| DryFarmland | 0.300 | 0.021 | 20.40 | 5.37 | 0.35 | 1.37 | 2.13 |
| City | 0.200 | 0.010 | 12.70 | 4.38 | 0.30 | 1.57 | 2.43 |
| Forest | 0.400 | 0.030 | 12.70 | 4.38 | 0.40 | 1.45 | 2.25 |

Key steps in obtaining experimental voles in the disclosure include (1) through (3). (1), trap placement is conducted in various habitats, including ridges of the farmlands, ditch embankments, lake beaches, and foot of the Dongting Lake embankments. A total of 100 traps is deployed at intervals of approximately seven human steps per trap. The traps are placed between 4:00 PM and 5:00 PM and recovered the following morning. A trapping rate is calculated as a number of trapped voles divided by a number of recovered traps. (2) The trapped voles and the traps are subjected to closed insecticidal and disinfection treatment using ether. The trapped voles are then classified. (3) Each of the trapped voles is dissected to determine a gender, a maturity status, and a pregnancy status, measure a body length, a tail length, a body weight, and a net weight, take out leg muscles, a stomach, and a tail, and preserve the leg muscles, the stomach, and the tail separately in bottles filled with alcohol and formaldehyde. All samples are retained for subsequent laboratory analysis, including muscle analysis and microscopic comparison of food contents in the stomach.

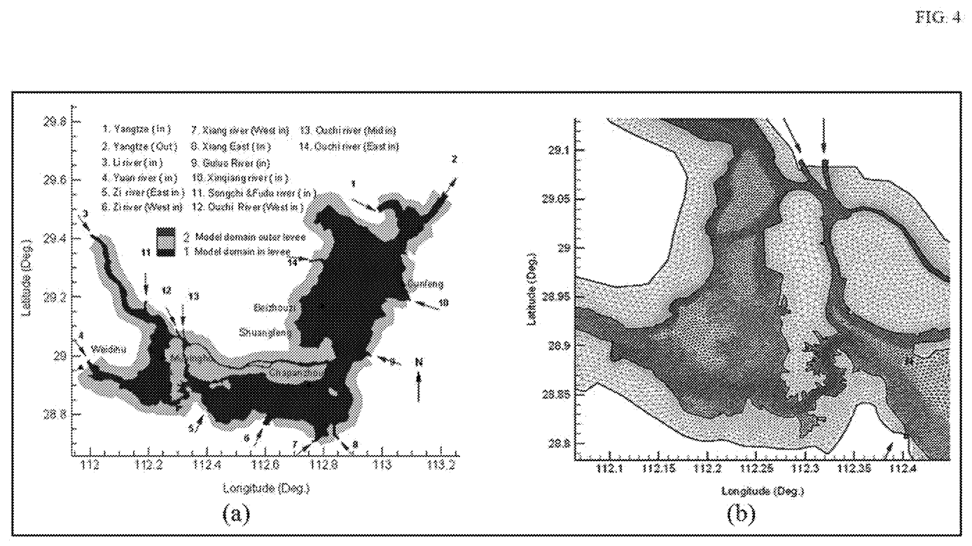

The hydrodynamic model and a two-dimensional sediment model constructed by the disclosure adopt an unstructured triangular grid system, with Gambit software used to generate the unstructured grid. Due to extremely complex boundaries and large area of the Dongting Lake, where an entire computation area exceeds 4000 square kilometers (km²), the unstructured grid with the triangular units as the basis is used for computation, as illustrated in FIG. 4. In order to facilitate accurate fitting of inner and outer boundaries and flexible control of grid unit density for local computation and overall grid unit number, lengths of edges of the grid units of the unstructured grid with the triangular units as basis are generally 100 meters (m) to 300 m in main river channels of the lake area, 60 m to 150 m in small river channels of the lake area and their tail sections, 400 m in the lake beaches, and 500 m to 600 m in outer areas of the Dongting Lake embankments. In order to avoid significant numerical diffusion in computation, transitions among the grid units with different scales are designed as smooth as possible, and a grid domain of the region surrounding the Dongting Lake and another grid domain of a region within 10 km outside an embankment of the Dongting Lake are divided by the lake embankment. The region within 10 km outside the embankment of the Dongting Lake is composed of farmlands, woodland and residential land. The two sets of grid domains should completely overlap considering computation of migration of the voles. An entire regional model consists of more than 62,363 grid nodes and 123,673 grid units. Considering that a vole problem is a two-dimensional problem, but due to a need to group the voles according to gender, age, and migration in each of the grid units, a specific storage volume of the unstructured grid is 123673×3×2×24. To improve a computation speed, only three of vertical grid nodes are taken. Additionally, to reduce a storage volume, data linking between a three-dimensional model and vole population models is performed instead of direct code coupling for computation. A one-dimensional model also employs this linking pattern.

### 1) the Quality Evaluation Model for the Habitat of Voles

Referring to a habitat quality evaluation method, a quality score of the habitat of voles at a time t in an ie-th grid unit of the unstructured grid is

$${Scor}_{ie}^{t} .$$

As illustrated in FIG. 3, main reference factors include soil, vegetation, land use type, flood inundation status, inundation depth, the density of voles, food, temperature, land surface runoff depth, soil moisture content, and density of predators. A formula of the quality evaluation model for the habitat of voles is expressed as follows:

$${Scor}_{ie}^{t} = {( \begin{matrix}{SSoilT}_{ie} \cdot {SPlantT}_{ie} \cdot {SLandU}_{ie}^{t} \cdot {SInund}_{ie}^{t} \cdot \\ {ScDens}_{ie}^{t} \cdot {SRs}_{ie}^{t} \cdot {ST}_{ie}^{t} \cdot {SMois}_{ie}^{t} \cdot {SEnem}_{ie}^{t}\end{matrix} )}^{\frac{1}{{n}^{′}}} ;$$

$$where , {Scor}_{ie}^{t}$$

represents the quality score of the habitat of voles at the time t in the ie-th grid unit of the unstructured grid, n′ represents a number of the reference factors (n′=9), SSoilTᵢₑ represents a scoring for different soil types, SPlantTᵢₑ represents a scoring for a vegetation type,

$${SLandU}_{ie}^{t}$$

represents a scoring for land use,

$${SInund}_{ie}^{t}$$

represents a scoring for water inundation,

$${ScDens}_{ie}^{t}$$

represents a correlation scoring of the density of the voles,

$${SRs}_{ie}^{t}$$

represents a scoring for water depth of habitat of voles

$${ST}_{ie}^{t}$$

represents a scoring for a ground temperature of the habitat of voles,

$${SMois}_{ie}^{t}$$

represents a scoring for the soil moisture content, and

$${SEnem}_{ie}^{t}$$

represents a scoring for natural enemies in the habitat of voles. Based on analysis of field surveys on burrow distribution and density of the voles, suitability scores for different soil types are assigned in the model. For example, the suitability scores for the soil types, including alluvial soil, calcareous sand, lake clayey soil, bog soils, and purplish soils, can be determined according to table 1. A suitability score for vegetation is mainly determined by vegetation height, edibility for reed voles, and water inundation depth, with related parameters determined according to table 2.

The quality score of the habitat of voles driven by the water inundation of the Dongting Lake wetlands is primarily determined by a formula expressed as follows:

$${SInund}_{ie}^{t} = \{ \begin{matrix}1 , & {Z}_{b} - {Z}_{s} > {D}_{max} \\ Max ( \frac{{Z}_{b} - {Z}_{s}}{2 \cdot {D}_{max}} + 0.5 , 0.01 ) , & \vert {Z}_{b} - {Z}_{s} \vert \leq {D}_{max} \\ 0.01 , & {Z}_{b} - {Z}_{s} < {D}_{max}\end{matrix} ;$$

$$where {SInund}_{ie}^{t}$$

indicates a change of quality of the habitat of voles caused by inundation, Dₘₐₓ represents a limiting maximum water depth under complete submergence conditions for different plants, assumed to be equal to half of a height of a trunk of a maximum plant. For different plant types of Populus, Phragmites australis, Carex tristachya, a mixture between Phragmites australis and Carex tristachya, a beach with sparse mixed vegetation and aquatic plants, values of the Dₘₐₓ are 2.0 m, 0.6 m, 0.2 m, 0.4 m, 0.1 m, and 0.08 m, respectively. Zₛ represents a water surface height at a center of a grid unit, and a value of Zₛ is mainly calculated by one-dimensional or two-dimensional models. Z_{b} represents a terrain height at the center of the grid unit at riverbeds, lakebeds, or beaches (i.e., a terrain elevation at a center of a habitat unit).

Since dynamics of the density of voles have a certain impact on the quality of the habitat of voles, especially when an actual density of the voles exceeds an environmental carrying capacity density of the habitat, insufficient food and burrow resources in the habitat will restrict habitation and development of voles, leading to a decrease in the quality of the habitat of voles and a corresponding quality score. Therefore, a formula for the correlation scoring of the density

$${ScDens}_{ie}^{t}$$

is expressed as follows:

$${ScDens}_{ie}^{t} = \sqrt{Max ( \frac{2 {D}_{ie}^{*} - {D}_{ie}}{2 {D}_{ie}^{*}} , 0.01 )} ;$$

$$where {D}_{ie}^{*}$$

and Dᵢₑ represent an environmental capacity density and the actual density of the voles at the t-th time in the ie-th grid unit of the unstructured grid, respectively.

### A Scoring Related to Surface Waterlogging is Expressed as Follows:

$${SRs}_{ie}^{t} = Max ( \frac{{S}_{Max} - S}{{S}_{Max}} , 0.3 ) ;$$

where S_{Max} and S represent a maximum land surface runoff depth and the land surface runoff depth, respectively; considering land surface vegetation and its micro-topography, the voles have ability to build nests using vegetation as grass balls, so they are generally not completely submerged; therefore, a minimum value is taken as 0.3.

### A Scoring Related to Temperature is Expressed as Follows:

$${ST}_{ie}^{t} = Max ( 1. - {( \frac{T - 20.}{20.} )}^{2} , 0.3 ) ;$$

where T represents a temperature of the habitat of voles and is determined by a spatial interpolation of downloaded Chinese meteorological data: (China meteorological data service system, abbreviated as CMDSS, http://cdc.cma.gov.cn/). High temperatures and solar radiation may affect migration intensity and energy consumption of the voles during a migration process.

### The Scoring for the Soil Moisture Content is Expressed as Follows:

$${SMois}_{ie}^{t} = Max ( 1. - \frac{WU + ML}{WM} , 0.3 ) ;$$

where WU, ML, and WM represent dynamic tension water contents (mm) of upper, middle, and lower soil layers, respectively; values of WU, ML, and WM are primarily calculated using a Xin'anjiang hydrological model, and when soil is directly submerged by water flow, these values reach saturation within a limited time; when the soil has a high amount of free water, the nests of the reed voles will be submerged and collapse, and the voles may migrate to other computation units to build new nests or choose to build nests on moss and reeds, an increase in the soil moisture content in the habitat of voles will increase the mortality rate of the voles, and the mortality rate of the voles is expressed as follows:

$$D = Min ( \frac{{D}_{ie , jgd , kag}}{{SMois}_{ie}^{t}} , {D}_{Aquatia \_ Veg} ) ;$$

where D_{ie,jgd,kag} and D_{Aquatia_Veg} represent a dynamic mortality rate of voles in a kag-th age and jgd-th gender group of the vole subpopulations in the ie-th grid unit and a mortality rate of voles in wetlands.

Due to the relatively scarce data on the natural enemies of the voles, for simplicity and considering human efforts to capture and poison voles migrating into farmland, the scoring for natural enemies in the farmlands is directly set to 0.3 in a single-species reed vole population computation model. In contrast, the voles living in the lake beaches are less affected by the natural enemies, making them relatively safe there, so the scoring for natural enemies is set to 0.9.

For established multi-population models, solutions are derived based on natural enemy population size, food chain relationships, and natural enemy food requirements, after certain parameter simplifications and process generalizations.

2) The Migration Model with the Age and Gender Structure for the Vole Subpopulations Based on an Individual Cohort-Based Model (ICBM)

When it is necessary to calculate short-term migration behavior of the voles, a solution formula is expressed as follows:

$${X}_{ie , jgd , kag}^{n + 1} = {X}_{ie , jgd , kag}^{n} + ( {U}_{flow} + α \cdot {Um}_{ie , jgd , kag} \cdot sin θ + \frac{\partial {D}_{x}}{\partial x} ) \cdot Δ t + R \sqrt{6 \cdot {D}_{x}^{*} \cdot Δ t} ;$$

$${Y}_{ie , jgd , kag}^{n + 1} = {Y}_{ie , jgd , kag}^{n} + ( {V}_{flow} + α \cdot {U}_{Max , jgd , kag} \cdot cos θ + \frac{\partial {D}_{y}}{\partial y} ) \cdot Δ t + R \sqrt{6 \cdot {D}_{y}^{*} \cdot Δ t} ;$$

$$where {X}_{ie , jgd , kag}^{n + 1} and {Y}_{ie , jgd , kag}^{n + 1}$$

represent grid coordinates of a specific position of the kag-th age and jgd-th gender group of the vole subpopulations at locations x and y at an (n+1)-th time step, respectively;

$${X}_{ie , jgd , kag}^{n} and {Y}_{ie , jgd , kag}^{n}$$

represent grid coordinates of the specific position of the kag-th age and jgd-th gender group of the vole subpopulations at the locations x and y at an n-th time step, respectively; U_{flow} and V_{flow} respectively represent water flow velocities in an x direction and a y direction, values of U_{flow} and V_{flow} are calculated by a two-dimensional hydrodynamic model, and when the reed voles migrate to a dry habitat, effects of values such as water flow velocity and wind speed disappear; U_{Max,jgd,kag} represents a maximum migration speed of the kag-th age and jgd-th gender group of the vole subpopulations, and a value of the Um_{ie,jgd,kag} is related to ages, genders, and habitat types of the voles; θ represents an included angle between a migration target grid unit and a source grid unit; α represents a speed correction coefficient, a correction value of α is closely related to quality score difference between two grid units involved, and a formula for α is α=Max (|ΔSc|)·U_{Max,jgd,kag}, 0.2), where |ΔSc| represents the quality score difference between the migration target grid unit and the source grid unit; Dₓ and D_{y} represents turbulence coefficients of water flow in the x direction and the y direction, respectively; n represents a last time step, * represents an (n+½)-th time step, (n+1) represents a current time step, Δt represents a time step length, and R represents a random time constant in arrange of [−1.0, 1.0].

Due to 96 possible movement groups of vole subpopulations and stack sub-aggregations in each of the grid units, a computation load of the model becomes extremely large when long-term computations are performed. Therefore, it is necessary to simplify the model. Considering that a duration required for the voles to migrate between two adjacent grid units is typically less than one time step length (i.e., Δx«Um_{ie,jgd,kag}·Δt), in a simplified computation scenario, it is assumed that migrating vole population can successfully reach the target migration grid unit, and a success rate of migration is determined based on remaining energy of the voles, with an assumption that there exists a certain functional relationship between the success rate of migration and the remaining energy of the voles before migration (vole reserve energy minus energy required for migration). The disclosure assumes that energy values of local gender and age groups of vole populations follow a normal distribution; based on a probability table of probability distribution, cumulative probabilities are obtained. By incorporating values of the reserve energy of the vole subpopulations dynamically calculated by the model, the success rate of migration of voles awaiting migration can be solved.

### (1) Selection of a Number of Migratory Habitat Units

In an absence of emergencies, such as when a habitat unit is not flooded, some voles will choose to remain in the same computation unit, while the rest of the voles will migrate to an optimal habitat unit. For special circumstances, it is assumed that: (I) due to relative weak migratory ability, all offspring voles with ages under 20 days remain in their original habitats; (II) all mothers of the offspring voles with ages under 20 days should stay in their original habitats; (III) in a case of remaining habitat, pregnant voles stay in their original habitats; (IV) under a condition of the remaining habitat, subadult voles will stay in their original habitats. In emergency situations, voles with the ages over 20 days will try to escape their original habitats and attempt to migrate to a safer habitat.

### (2) Habitat Selection Method Based on Quality Score Difference Among Habitats, Maximum Density, and Energy Control

It is assumed that the reed voles with ages over 20 days possess ability to judge or follow migration of other older groups of reed voles based on specific circumstances and can migrate to an adjacent superior alternative grid unit within one time step length. When evaluating adjacent superior alternative grid units, it is necessary to dynamically assess whether densities of the voles in these grid units are saturated. When the densities are saturated, vole groups will migrate to other alternative grid units.

### 3) the Size Change Model for the Vole Populations

At a next time step, a number of voles in a specific age and gender group of the vole subpopulations is determined according to the following method. When the ages of the voles are greater than 20 days, a formula for calculating the number of the voles in the specific age and gender group of the vole subpopulations is expressed as follows:

$${P}_{ie , jgd , kag}^{n + 1} = {Psk}_{ie , jgd , kag}^{n} \cdot ( 1 - {Dsk}_{ie , jgd , kag} ) + {\sum }_{nm = 1}^{Num ( ie , jgd , kag )} {Pmw}_{ie , jgd , kag , nm} \cdot ( 1 - {Dmv}_{ie , jgd , kag , nm} ) ; where ,$$

$${P}_{ie , jgd , kag}^{n + 1}$$

represents a number of voles in the kag-th age and jgd-th gender group of the vole subpopulations in the ie-th grid unit at the (n+1)-th time step, Pskⁿ_{ie,jgd,kag} represents a number of voles in the kag-th age and jgd-th gender group of the vole subpopulations in the ie-th grid unit at the n-th time step, Pmv_{ie,jgd,kag,nm} represents a number of voles that may migrate from a total of Num(ie,jgd,kag) grid units adjacent to the ie-th grid unit to the kag-th age and jgd-th gender group of the vole subpopulations in the ie-th grid unit within a time step length from the n-th time step to the (n+1)-th time step, and nm represents a serial number of a grid unit adjacent to the ie-th grid unit; Dsk_{ie,jgd,kag} represents a death rate of the voles in the kag-th age and jgd-th gender group of the vole subpopulations in a static stack area (namely, voles in the kag-th age and jgd-th gender group of the vole subpopulations in the ie-th grid unit staying in the ie-th grid unit without migration) of the ie-th grid unit, and Dmv_{ie,jgd,kag,nm} represents a death rate of the voles that migrate from all the grid units adjacent to the ie-th grid unit to the kag-th age and jgd-th gender group of the vole subpopulations in the migration target grid unit of the ie-th grid unit.

The ages of the voles are less than 20 days, and the number of the voles that migrate to the kag-th age and jgd-th gender group of the vole subpopulations in the ie-th grid unit is not taken into account: (1) when the ages of voles are less than 10 days, these newborn voles in the habitat are directly computed into a first age group of the vole subpopulations using a mortality of the newborn voles in the ie-th grid unit and then accumulated. The formula for calculating the

$${P}_{ie , jgd , kag}^{n + 1}$$

is expressed as follows:

$${P}_{ie , jgd , kag}^{n + 1} = {Psk}_{ie , jgd , kag}^{n} \cdot ( 1 - {Dsk}_{ie , jgd , kag} ) + {Δ P}_{igd}^{n + 1} \cdot {( 1 - {Dsk}_{ie , jgd , kag} )}^{Mod} ( n , \frac{86400 \times 20}{Δ t} ) ;$$

where a total number of the newborn voles

$${Δ P}_{igd}^{n + 1}$$

within the time step length from the n-th time step to the (n+1)-th time step is expressed as follows:

$${Δ P}_{igd}^{n + 1} = {\sum }_{kag = 1}^{Maxag} {P}_{1 , kag}^{n} \cdot {Rpreg}_{kag} \cdot {B}_{kag} \cdot {R}_{jgd} ; where ,$$

$${P}_{1 , kag}^{n}$$

represents a total number of mature female reed voles within the time step length from the n-th time step to the (n+1)-th time step, Rpreg_{kag} represents a pregnancy rate of the voles, B_{kag} represents an average litter size, and R_{jgd} represents a gender ratio of the newborn voles. A pregnancy period T_{Duration} of the voles is 20 days. Based on survey, a pregnancy ratio of the mature female reed voles is about 35%; therefore, the pregnancy rate in the time step length Δt in modelling system for the female voles is

$${Rpreg}_{kag} = 0.35 \cdot \frac{Δ t}{{T}_{Duration}} ,$$

B_{kag} is averaged baby individuals in a nest; and R_{jgd} is equal to the gender ratio of the newborn voles (♀ (number of female voles)/(♂(number of male voles)+♀), based on the survey, a value of the R_{jgd} is set to 60%.

When the ages of the voles are larger than 10 days but less than 20 days and the number of the voles that migrate to the kag-th age and jgd-th gender group of the vole subpopulations in the ie-th grid unit is not taken into account, the formula for calculating the

$${P}_{ie , jgd , kag}^{n + 1}$$

is expressed as follows:

$${P}_{ie , jgd , kag}^{n + 1} = {Psk}_{ie , jgd , kag}^{n} \cdot ( 1 - {Dsk}_{ie , jgd , kag} ) ;$$

however, at this point, the newborn voles from age-eligible female voles are separated by gender and cumulatively stored in a reserved stack of each of the grid units, with a mortality rate assumed to be 0. These newborn voles wait until an oldest age group of voles in each of the grid units reaches 480 days and dies off entirely and then are recruited together into a youngest age group, thereby initiating a new survival trajectory computation. This approach ensures that the model maintains consistency in calculating ages of the voles.

### (1) Mortality Rate

The mortality rate of the reed voles is primarily influenced by the ages of voles, types of the habitats, and the densities of voles and their predators. The specific values of the mortality rate are determined according to table 2. A maximum age of the oldest age group of voles is set based on a literature (Zhang and Wang, 1998). When ages of the voles exceed 480 days, all individuals in this age group are assumed to die, and the newborn voles are recruited into the youngest age group. Although a small number of voles may live longer than 480 days, their ecological functions are considered negligible. Therefore, this modeling assumption is reasonable.

### (2) Solution for Continuous Succession of Population Stack

Stack update and recruitment of the newborn voles are crucial to population solution. The disclosure through trial computation shows that different recruitment and update solutions have a certain degree of “fluctuation” influence on computation results, while death “removal” has less influence on the fluctuation. The smaller the time step (Δt=20d) of a selected population sub-stage, the smaller the fluctuation of stack update computation, but the small time step of the population sub-stage undoubtedly increases a computation amount and storage volume to a greater extent. In order to comprehensively consider the fluctuation and their effective computations, the disclosure divides newborn subgroups into two stages for updating, which undoubtedly reduces fluctuations in solution. Specific steps of an algorithm designed by the disclosure include step (1) through step (2).
Step (1), voles born between 0-10 days are directly incorporated into the youngest vole population in their birth habitat by continuously calculating.
Step (2), voles born between 10-20 days are directly stored in a fixed stack and wait for the oldest subpopulation to be calculated until they die off and exit the stack, and then the voles are directly updated into this subpopulation with their ages set to 0 days. This approach realizes the continuous computation of the population. This algorithm essentially equates to the actual age of a vole population aged 0-10 days increasing by 0-10 days, and the actual age of a vole population aged 10-20 days decreasing by 0-10 days, with the two effects canceling each other out to result in a net change of zero. This updating method enables continuous computation for population succession.

### (3) Integration of Voles Having the Same Age and Gender

When using a two-dimensional model for detailed computations, coordinates of the vole subpopulations at each time step may not necessarily be located at a center of the computation unit. When there are two or more vole subpopulations of the same age and gender in the same grid unit, fusion is required before further computations. Main factors that need to be fused are the coordinates of the vole subpopulations, numbers of the vole subpopulations, and biological energy carried by the vole subpopulations. Computation formulas for coordinates of X and Y are expressed as follows:

$${X}_{ie , jgd , kag}^{t + 1} = \frac{{\sum }_{n = 1}^{Num ( ie , jgd , kag )} {Pmw}_{ie , jgd , kag , n} \cdot {Xmv}_{ie , jgd , kag , n}^{t + 1} + {Psk}_{ie , jgd , kag} \cdot {Xsk}_{ie , jgd , kag}^{t + 1}}{{Psk}_{ie , jgd , kag} + {\sum }_{n = 1}^{Num ( ie , jgd , kag )} {Pmv}_{ie , jgd , kag , n}} ;$$

$${Y}_{ie , jgd , kag}^{t + 1} = \frac{{\sum }_{n = 1}^{Num ( ie , jgd , kag )} {Pmv}_{ie , jgd , kag , n} \cdot {Ymv}_{ie , jgd , kag , n}^{t + 1} + {Psk}_{ie , jgd , kag} \cdot {Ysk}_{ie , jgd , kag}^{t + 1}}{{Psk}_{ie , jgd , kag} + {\sum }_{n = 1}^{Num ( ie , jgd , kag )} {Pmv}_{ie , jgd , kag , n}} ; where$$

$${Xmv}_{ie , jgd , kag , n}^{t + 1}$$

represents an x coordinate of a kag-th age and jgd-th gender group of the vole subpopulations migrating to the ie-th grid unit at a time t+1,

$${Xsk}_{ie , jgd , kag}^{t + 1}$$

represents an x coordinate of the kag-th age and jgd-th gender group of the vole subpopulations in the source grid unit of the ie-th grid unit, and other y coordinates have similar meanings.

During computation, it is assumed that coordinates of the vole subpopulations without migration are located at the center of the computation unit.

### (4) Bioenergetics Computation and its Equilibrium Model of Rodents

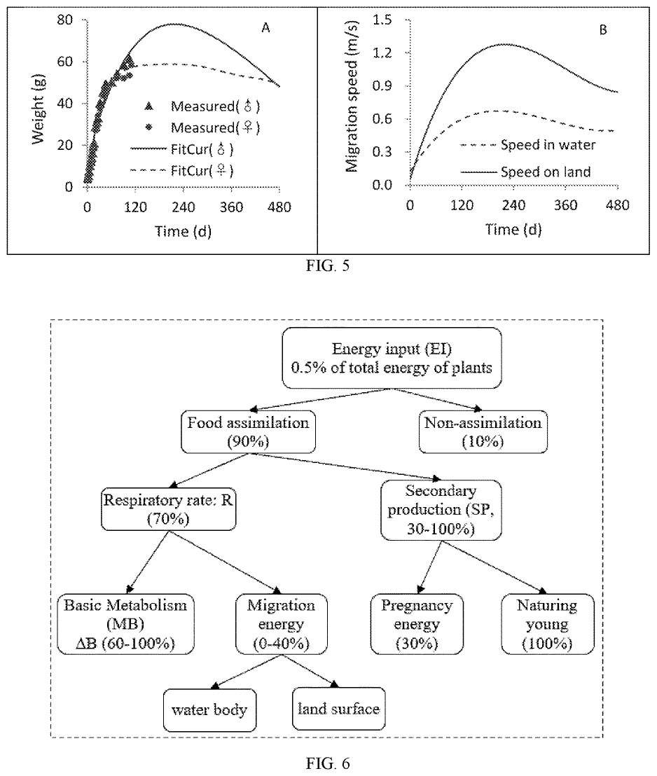

Maintenance, growth, reproduction, daily movement, nest building, burrow digging, evasion of natural enemies, and foraging of individual organisms all require energy. Among three types of rodents, only the reed voles mainly inhabit lake beaches that are easily flooded. In order to avoid rising floods, the reed voles need to undergo high-intensity migration from June to August each year. Populations of the other two types of rodents have lower migration frequencies in terms of energy consumption and have freedom to choose rest opportunities. During a migration process for avoiding floods, a large amount of biological energy is consumed, the density of the voles is high, food along a migration route is limited to some extent, and to meet the energy supply requirements for migration, sometimes the reed voles will use carcasses of the same species that have died due to migration exhaustion as food. In addition, during pregnancy and litter-giving periods of the reed voles, they need to go out more to forage for food to supplement bioenergy. Inherent stored biological energy is crucial for the migration and feeding of the reed voles, so appropriate simplifications are made in the computation process to avoid excessive storage and computation: 1) only considering energy flow of the reed voles, 2) additional energy consumption mainly considering migration energy consumption of voles and the energy consumption during female pregnancy (10-30%) and offspring nurturing (45-200%), 3) establishing a connection between the inherent stored biological energy of the reed voles and their migration success probability, and 4) simplifying other populations and energy consumption of other populations accordingly. FIG. 6 illustrates primary energy allocation and their proportions of the vole populations based on relevant literature surveys.

### 1) Energy Input Ein

Energy input of reed voles and Apodemus agrarius is closely related to types of their habitats and vegetation distribution (with a maximum value of approximately 10-20% of habitat productivity; Gefeng et al., 2008, table 6-20-3, pp. 388). In the disclosure, a normalized difference vegetation index (NDVI) value of the habitat of voles is adopted as the energy input: Ein=(NDVI_{T}). Energy input of Rattus norvegicus is mainly closely related to production patterns of enclosures and the biomass of agricultural crops.

### 2) Energy Output Eout

Basal metabolic rate (BMR) is determined based on animal's own weight, and animal's energy requirement is: Mb(kJ)=70 W^{b}, where Kleiber (1961) set b=0.75 in calculating basic metabolism (Mb) process of animals.

### 3) Migration Energy Consumption Rate EMov

Forces required for the voles to swim through water and their energy consumption rate are determined using formulas expressed as follows:

$${E}_{SW} = {R}_{GW} \cdot Δ t + {F}_{D} \cdot L ; where :$$

$${R}_{GW} = ( {M}_{M} - {M}_{f} ) g ;$$

$${F}_{D} = \frac{1}{2} {C}_{D} {ρA}_{fr} \vert {U}_{M} - {U}_{f} \vert ( {U}_{M} - {U}_{f} ) ;$$

$${C}_{D} = \{ \begin{matrix}\frac{24}{Rep} ( 1 + 0.15 {Re}_{P}^{0.687} ) , & {Re}_{F} \leq 800 \\ 0.44 , & {Re}_{F} \leq 800\end{matrix} ;$$

where, F_{D} represents an effective gravity of a vole in water, M_{M} and M_{f} represent a weight of the vole in air and its underwater weight when the body volume is considered, respectively, g represents a gravity acceleration, R_{GW} represents a kinetic metabolic rate (joule per second, abbreviated as J/s) required to prevent the vole from sinking, F_{D} represents a drag force exerted by the water flow on the vole in the water, A_{fr} is an effective water contact area when the vole is swimming.

$${Re}_{P} = \frac{{d}_{M} {U}_{f} ρ}{μ} ,$$

d_{M} represents an effective diameter of the vole facing a water surface when swimming and moving, Ur represents a velocity of the water flow, p represents a density of the water flow, u represents a viscosity coefficient of the water flow, the energy consumption rate of the vole in water is E_{LD}=R_{GL}·Δt+Max (DZ)·M_{M}g, and L represents a migration distance of the vole.
4) Growth energy consumption rate: during a growth period, a portion of the energy consumption of the voles is primarily used to meet energy requirements for bodily tissue growth.
5) Pregnancy additional energy consumption rate is 30% of the basal metabolic rate of the voles.
6) Nurturing additional energy consumption rate is 40%-100% of the basal metabolic rate of the voles. A value of the nurturing additional energy consumption rate is closely related to a number of offspring being nurtured.

Storage energy Eₛₜₖ and energy storage threshold Esko of voles: when inherent stored bioenergy of a vole is less than the energy storage threshold Esko, the vole needs to go out to search for food and feed, due to a lack of measured data, it is assumed in the computation process that the energy storage threshold Esko of voles is equal to the basal metabolic rate of voles for one day: Eₛₖ₀=1.0×86400× Mb, namely, assuming that voles can survive for one day in a stationary state with this energy storage, when dynamic storage energy of voles falls below the energy storage threshold, the voles need to supplement energy in time to increase their storage energy, and due to limitations of volumetric capacity of voles' stomachs and their bodies for storing biological energy, a maximum value of the storage energy is equivalent to the basal metabolic rate of voles for two days: Eₛₖₘₐₓ=2.0×86400× Mb.

An energy storage process model of the reed voles at each time step length is:

$${E}_{sk , ie , jgd , kag}^{n + 1} = {E}_{sk , ie , jgd , kag}^{n} + {EIn}_{ie , jgd , kag} - {Mb}_{ie , jgd , kag} \cdot Δ t - {EMov}_{ie , jgd , kag} - {EAdd}_{ie , jgd , kag} ; where$$

$${E}_{sk , ie , jgd , kag}^{n + 1} and {E}_{sk , ie , jgd , kag}^{n}$$

represent energy values of the kag-th age and jgd-th gender group of the vole subpopulations living in the ie-th grid unit at the (n+1)-th time step and the n-th time step, respectively; EIn_{ie,jgd,kag} represents an energy supply obtained by the voles in the kag-th age and jgd-th gender group of the vole subpopulations living in the ie-th grid unit within the time step length Δt, Mb_{ie,jgd,kag} represents energy consumption rate due to basal metabolism of the kag-th age and jgd-th gender group of the vole subpopulations living in the ie-th grid unit, EMov_{ie,jgd,kag} represents energy consumed by the kag-th age and jgd-th gender group of the vole subpopulations living in the ie-th grid unit during migration in the time step length Δt, and EAdd_{ie,jgd,kag} represents additional energy consumed by the kag-th age and jgd-th gender group of the vole subpopulations living in the ie-th grid unit in digging burrows and nurturing young within the time step length Δt, and Δt represents the time step length.

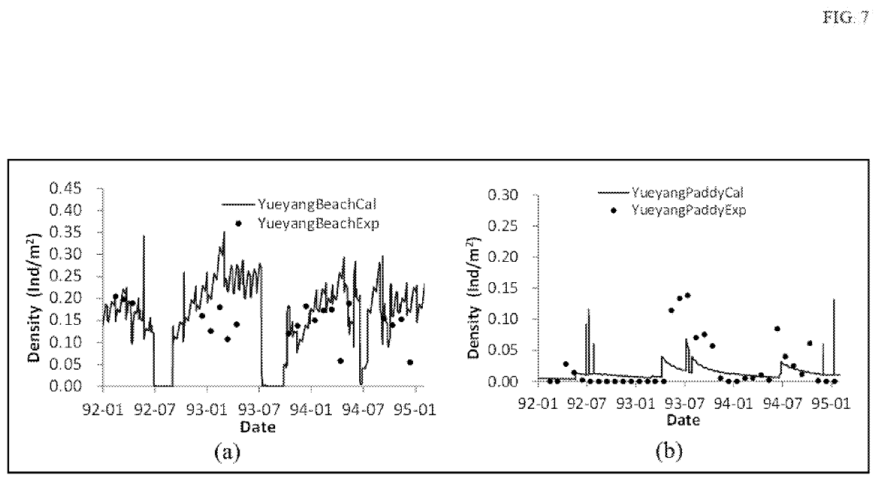

To verify and validate rationality of model parameters and correctness of computations, the disclosure uses actual measured densities of voles in lake beaches and farmlands in Yueyang during 1991-1995 to validate the model. A validation diagram (FIG. 7) illustrates that during dry seasons of 1993-1995, the density of the reed voles living on the lake beaches is relatively high, reaching approximately 0.2 Ind./m², while the density of the reed voles living in the farmlands during this period is very low. When floods approach, the lake beaches are submerged, and some of the reed voles living on the lake beaches successfully cross lake embankments and migrate into the farmlands, causing the density of the reed voles living in the farmlands to increase rapidly to 0.1 Ind./m² to 0.15 Ind./m². As the floods recede, the reed voles living in the farmlands partially return to central zones of the lake beaches (or are poisoned by local farmers, resulting in a decrease in population density). It can be seen from FIG. 7 that computation values of the model show good agreement with measured values in the lake beaches, while computation errors are relatively larger in the farmlands, which may be closely related to microhabitats in the farmland. In the farmlands, a grid resolution of the model is relatively low, and movement of the voles primarily occurs along inner sides of farmlands or along ridges of the farmlands for habitation and migration, which may differ from an averaged density of voles in the habitat assumed by the model. However, computation accuracy of the model reaches approximately 40%, and considering strong heterogeneity of the habitat and numerous biological parameters involved, the computation values are reasonable.

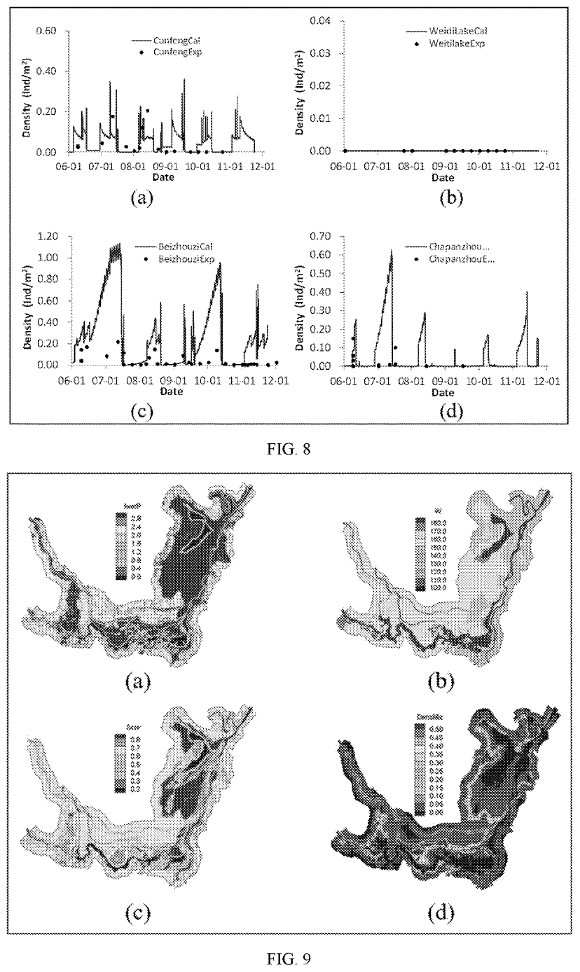

As illustrated in FIG. 8, validation of the model is primarily conducted in Chunfeng, Chapanzhou, and Baizhouzi in Yueyang. These habitat units have been largely reclaimed since 1998, especially after 2009, when the measured densities of voles in these areas tended to approach zero, showing a significant discrepancy with the calculated values. In contrast, the calculated values of the model are relatively well aligned with measured values in 2009. This may be closely related to factors such as effective management of reclaimed areas, establishment of rodent control walls, and simplification and parameters of migration patterns of the model. Because rodent control measures of humans have a significant impact on reclaimed embankment areas, and currently the model does not yet consider active control measures by humans involving the migration of voles, such as interference and poisoning.

### (1) Simulation of a Vole Disaster Accident in 2007 in the Dongting Lake Using Model Computation

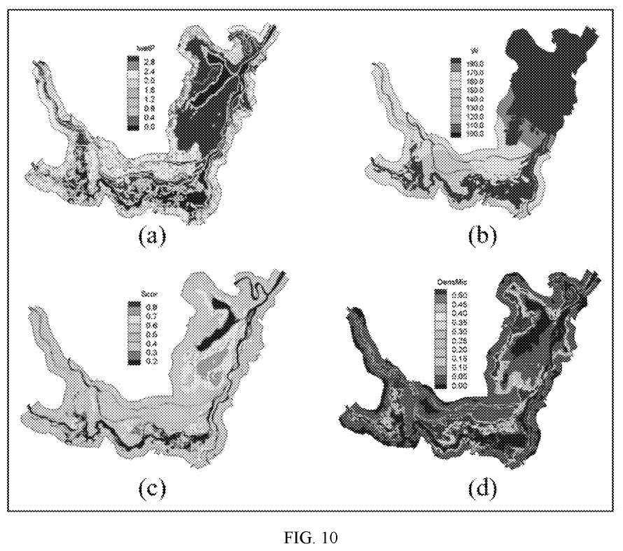

The vole disaster accident in 2007 in the Dongting Lake is the largest outbreak of reed vole disaster in history. In the computation process, nine feature variables are used to describe the dynamic quality of the habitat of the reed voles in the Dongting Lake region. Among these feature variables, two key feature variables are inundation factor and soil moisture content. The former is closely related to the migration and escape behavior of the reed voles, while the latter directly affects conditions of nests of the reed voles, because excessively high soil moisture content can cause the nests to collapse. Therefore, particular emphasis is placed on the two feature variables, along with comprehensive evaluation scores of the habitat calculated by the model and the spatiotemporal changes in density of voles calculated by the model (see FIG. 9 through FIG. 12).

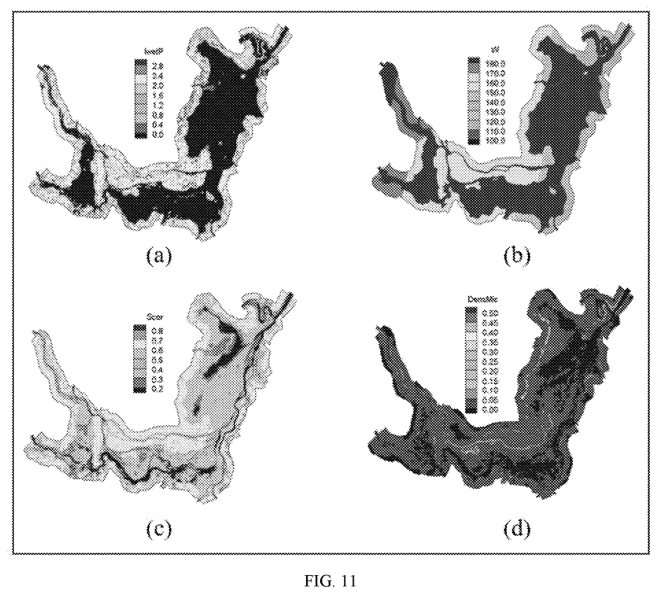

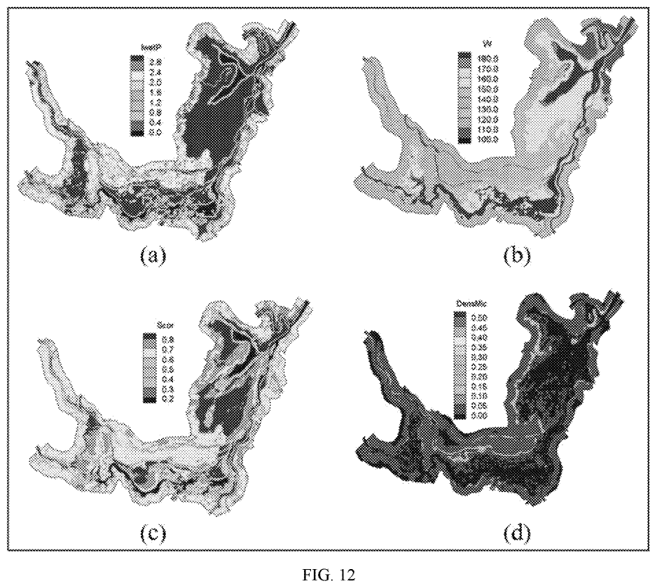

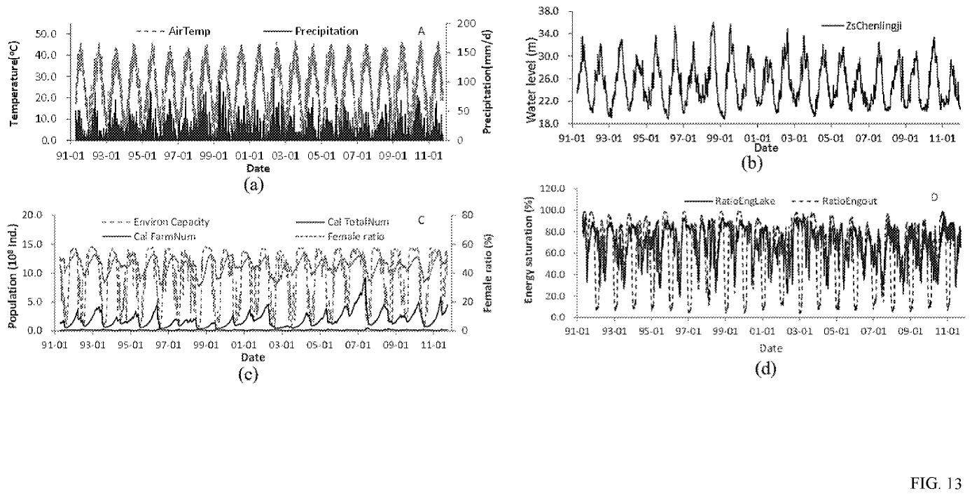

It can be seen from FIG. 9 through FIG. 12 that in 2005 and 2006, due to a lack of significant precipitation and upstream floods for two consecutive years, combined with the Three Gorges Reservoir being impounded to 156 m from September to October 2006, water level and inundation extent in the Dongting Lake region are significantly lower than normal years, resulting in low soil moisture content on the lake beaches. Consequently, before flood in 2007, the reed voles have a longer reproducing time and higher reproducing speed on sandbanks, leading to a large population base (d in FIG. 9 and FIG. 13). After Jul. 28, 2007, due to heavy precipitation in middle reaches and pre-flood water release from the Three Gorges Reservoir, grasslands in the Dongting Lake region are rapidly submerged, leading to a rapid decline in the quality score of the habitat in the grasslands (falling below 0.4). Concurrently, the quality score of the habitats in the farmlands can reach above 0.6. As a result, large numbers of reed voles inhabiting the lake beaches migrate towards the farmlands. During the migration process, the voles consumed various crops and tree barks along the migration routes, thereby causing a large-scale vole disaster. During the migration process, a large number of elderly vole individuals and subadult voles with insufficient physical strength die from flood inundation and long-distance migration due to physical exhaustion. Additionally, local farmers, in order to prevent the voles from invading the farmlands, kill a large number of voles at places where the voles must pass during migration, such as outer sides of lake embankments and the ridges of the farmlands, leading to a rapid reduction in sizes of the vole populations. According to computations, under normal conditions, only about ⅛ of the voles from the lake beaches can successfully migrate to peripheral lake embankments, farmlands, high beaches, and hills and survive. In target habitats of migration, the reed voles will engage in habitat sharing and competition with local populations such as Apodemus agrarius and Rattus norvegicus. The reed voles adopt an r-reproductive strategy (high reproductive rate), which prevents the vole populations from declining and becoming extinct, and this is closely related to hydrological processes in the region (d in FIG. 11). After the flood, due to exposure of the lake beaches, the quality scores of habitats in the lake beaches are relatively high, a large number of reed voles that have migrated out from the lake beaches return to optimal habitats in the lake beaches to initiate a new reproductive cycle (c in FIG. 12). Subsequently, the reed voles begin a new cycle.

### (2) Numerical Computation for Changes of the Vole Populations

The reed voles in the Dongting Lake region, like other small rodents, have a very fast reproduction rate and short lifespan, with their population dynamics classified as an r-selection type. Before natural enemies are extensively eliminated or hunted by humans, the changes of the vole populations are mainly controlled by regional precipitation, inundation hydrological processes of wetlands, and natural enemy populations. After the natural enemies are extensively reduced due to large-scale broad-spectrum poisoning, the changes of vole populations are primarily controlled by hydrological processes of the wetlands. In addition, construction of vole control embankments, farmland reclamation in lake areas, evolution of sand beaches, and numerous water conservancy projects have also had a significant impact on the reed vole populations. This section uses a mathematical model established by the disclosure to calculate a change process of the reed vole populations in the Dongting Lake region from 1991 to 2011 (c in FIG. 13). During this period, it can be assumed that sizes of populations of main natural enemies (such as owls, weasels, snakes, etc.) of the reed voles have been reduced to very low levels, and ecological function of the main natural enemies of controlling the size of the vole populations has basically been lost. Therefore, a vole population model coupled with interval hydrology, hydraulics, and habitat dynamics evaluation models is used for computation. Calculated values align with actual population numbers reported in severe vole disaster records for 1993, 1995, 2007, and 2010. However, the computation values of the mathematical model are relatively high in 2002 and 2005, yet no major vole disasters are observed during these years. Survey results of lake beaches in 2005 show a high density of voles. However, due to small floods in flood season of the Yangtze River in 2005 and less precipitation on the lake beaches, although the vole population base is very large, absence of significant flooding prevented the voles from migrating out of the lake beaches to cause the vole disaster. Therefore, computation results of the mathematical model are reasonable and consistent with actual situation. The surveys on the density of voles in the lake beaches in 2002 indicate that the density of voles is indeed very low that year. Computation values of the model in 2002 have a certain degree of error. However, referring to temperature, precipitation, and hydrological processes from 2001 to 2002, there were no significant precipitation or floods, nor any extreme temperatures. Reasons for the low density of voles may include inaccurate parameters, population collapse, interference competition from other populations, or poisoning, but specific reasons require further verification and research. From the computation results of the model, it can be seen that when the numbers of voles in the computational region reach 2.0×10⁸, the vole populations are prone to migrate out and cause disasters during flood inundation in the flood season. The model accurately simulated the major disaster of reed voles in the Dongting Lake region in 2007, with a calculated peak value of voles reaching up to 8.0×10⁸. According to estimates by relevant departments that year, an actual maximum number of voles reaches 20×10⁸. Main reasons for underestimation of the calculated values of the model compared to the actual maximum number of voles may be: (I) an estimated uniform distribution density of voles in lake beaches used in computation (5 Ind./m²) does not conform to the actual conditions; (II) an actual area of lake beaches in the region surrounding the Dongting Lake is larger than an area of a region simulated by the model, so actual numbers of the vole populations may be greater than the computation results; (III) in addition, an actual birth rate and an actual mortality rate of the voles are higher than the values used in the model. At the same time, it can be seen from FIG. 13 that the environmental carrying capacity of voles within the computation area of the model is approximately 8.0×10⁸ Ind during the dry season, and less than 100 million (with some relation to magnitude of the flood) during the flood season. Under stress of environmental carrying capacity, the reed voles undergo changes in their own populations. From a process chart showing a number of newborn voles and a number of vole deaths calculated by the model, it can be seen that a large number of voles die during floods, with the number of vole deaths exceeding the number of newborn voles, leading to a decrease in sizes of the vole populations. The changes in the sizes of the vole populations during the dry season are in a contrast. Changes in the sizes of vole populations in farmlands are primarily determined by the migration of the reed voles, and a peak number of voles in the farmlands is approximately 0.3×10⁸ Ind. After the flood season, the sizes of the vole populations decline rapidly, and only a very small number of reed voles overwinter in the farmlands.

### (3) Simulated Computation for Changes in Gender and Age Structures of the Vole Populations

Field investigations show that an average gender ratio of newborn reed voles is 6:4 (female:male). However, female voles expend significantly more additional energy and face greater exposure in the wild during pregnancy and offspring nurturing. During escaping from floods, the female voles are sometimes affected by their offspring, missing optimal migration opportunities. Additionally, the female voles have lower migration speed and endurance compared to male voles of the same age. Therefore, the female voles have a relatively lower probability of successfully escaping during floods compared to the male voles. As a result, a proportion of the female voles drops significantly after the flood. During a 1998 major flood, the proportion of the female voles decreased to approximately 26%. However, in the dry season, the proportion of the female voles can recover to around 50% due to the initially higher proportion of the female voles at birth, and the proportion of the female voles shows a strong correlation with the hydrological processes. The gender ratio of the reed voles can be considered to be constrained and stressed by the hydrological processes. After a major flood, only a portion of subadult and adult voles (approximately ⅛ of the vole populations) are able to successfully migrate into the farmlands. Additionally, the voles migrating to the farmlands face habitat competition from the Rattus norvegicus and the Apodemus agrarius in the farmlands, as well as various human defense and predation activities. Therefore, it can be concluded that under conditions without effective natural enemy control, a flood process in the lake region regulates the changes of the vole populations. Large-scale spatial precipitation reduces the birth rate of the reed voles and increases the mortality rate of the reed voles. The hydrological process of alternating flood and drought is important for maintaining the vole populations and change process of genders of the voles and is a main factor of external environmental stress.

### (4) Simulated Computation for Changes in Age Structures of the Vole Populations

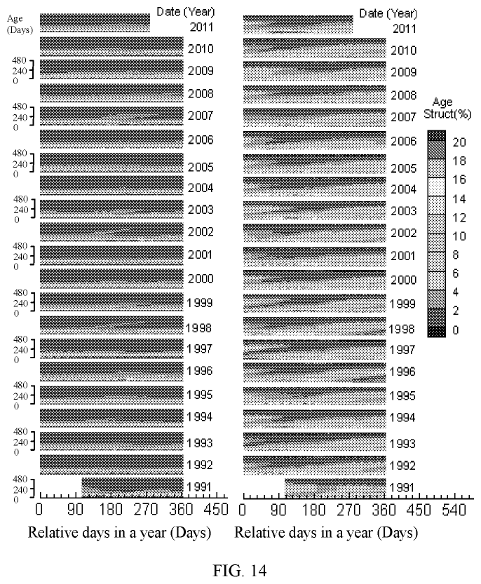

In the model, the reed voles are divided into 24 age groups with an age interval of 20 days. The model is capable of calculating changes of age structure of voles in different habitat units over time (with a resolution of 30 minutes). Among these, distribution diagrams of calculated results of age structures of voles in the lake beaches inside the lake embankments and the farmlands outside the lake embankments are illustrated in FIG. 14. A proportion of offsprings in the vole populations in lake beaches of the Dongting Lake is relatively large, reaching over 33%, while a proportion of elderly individuals is less than 0.1%. This indicates that only an extremely small number of voles die from old age and exhaustion. An age structure of the vole population in the lake beaches exhibits a typical pyramidal distribution, featured by high birth rate and rapid population growth. In contrast, an age structure of vole populations in the farmlands outside the lake embankments differs significantly from that within the lake embankments. Main age groups of the vole populations in the farmlands are concentrated in subadults and adults, with relatively fewer elderly and newborn voles (<25%). An age structure of the vole populations in the farmlands is more diverse and less stable than that of vole populations in the lake beaches. This primarily indicates that changes in structure of the vole populations in the lake beaches are mainly caused by migration of voles rather than succession occurring within a closed system. Such an age structure of the vole populations in the farmlands belongs to a diamond-shaped distribution structure. Simultaneously, the age structure of the vole populations in the farmlands outside the embankments shows a higher proportion of newborns before July, which is a result of natural development of voles living in the farmlands. After July, the age structure of the vole populations in the farmlands undergoes rapid changes, primarily due to the migration of the voles from the lake beaches. However, after February-March, a bimodal characteristic of the age structure emerges (with higher proportions of both young and old age groups of reed voles), which is mainly a result of combined effects of voles that have not migrated back to the lake beaches and their high reproductive rate. As can be seen from FIG. 14, the age structure of the vole populations is mainly determined by its high reproductive rate, mortality rate, and the migration process. A dynamic flooding process of wetlands of the lake beaches undoubtedly strongly drives age structures of vole populations in different habitats and further influences dynamic process of the reed vole populations.

By taking the changes of reed vole populations in the region surrounding the Dongting Lake as a research object and using numerical simulation as main research means, main achievements obtained by the disclosure are as follows. (1) By selecting habitat soil, vegetation, land use, precipitation, flood inundation, soil moisture content, and density of voles as reference factors, a habitat quality evaluation model for the reed voles in the region surrounding the Dongting Lake is established using the geometric mean method and coupling distributed hydrology model and one-dimensional/two-dimensional hydrodynamic models. (2) Through field surveys and sampling and relevant historical data collection, key parameters such as growth, reproduction, and migration of the reed voles are analyzed. A size change model and a migration model for the reed voles in the region surrounding the Dongting Lake are established. (3) The habitat quality, population changes, and dynamic process in gender and age structure of the reed voles in the Dongting Lake region from 1991 to 2011 are reconstructed. The computation results can reflect several outbreak processes of reed vole disaster, such as the major disaster outbreak of the reed voles in 2007. (4) Specific computations of the model reveal that an inundation process in the Dongting Lake wetland is one of main driving forces for adjustments in the population, migration, and gender and age structure of the reed voles. Through further extension of the research, a preliminary model has been established for the population, community succession, and energy flow of key species at different levels of a biological chain closely related to the reed voles, including owls, weasels, snakes, Apodemus agrarius, reed voles, and Rattus norvegicus in the habitat surrounding the Dongting Lake, and basic computation formulas are derived. By integrating the distributed hydrological model of the entire Yangtze River basin grid and the hydraulic model of the middle reaches of the Yangtze River network established in the embodiment, the model couples scheduling processes of all large reservoir groups in the Yangtze River Basin. Further research can quantitatively calculate the ecological succession and energy flow processes of rodent populations dominated by reed voles and their major natural enemies in the region surrounding the Dongting Lake. Additionally, impacts of the scheduling processes of large reservoir groups (including the Three Gorges Reservoir and the large reservoir groups of the four rivers of the Dongting Lake) on wetland changes in the region surrounding the Dongting Lake area, changes in population, gender and age structure, and energy flow of reed voles and Apodemus agrarius. The disclosure has significant value in deepening understanding of associated processes and mutual influences among reservoir group scheduling, hydrological and water environmental changes, habitat quality changes, and biological energy flow, migration, population, community changes, and succession. At the same time, the disclosure has a positive effect on recognizing and effectively controlling rodent disasters in the Dongting Lake area.

The disclosure establishes a system integrating a river network flow-sediment model, a vegetation model dependent on vole habitats, and a dynamics model of vole populations, and quantitatively researches impacts of changes in areas of lake beaches, reservoir scheduling, and lake reclamation on changes of vole populations in the Dongting Lake region. The disclosure not only demonstrates significant innovation in research methods but also holds important implications for effectively controlling vole disaster outbreaks.

Based on a same concept, the disclosure further provides a quantitative prediction device for the changes in the spatiotemporal distribution of the vole populations. The quantitative prediction device includes a habitat division module, a first model construction module, a second model construction module, a third model construction module, and a prediction module.

The habitat division module is configured to determine the habitat of voles based on the activity range of the voles and divide the habitat of voles into the unstructured grid with the triangular units as basis.

The first model construction module is configured to determine the environmental change parameters of the habitat of voles and the density of the voles as the reference factors, calculate the spatiotemporal change result of each of the reference factors, and construct the quality evaluation model for the habitat of voles using the geometric mean method based on the spatiotemporal change result of each of the reference factors.

The second model construction module is configured to group the voles in each of the grid units of the unstructured grid according to the ages and genders to obtain the grouping results as the vole subpopulations, construct, based on the grouping results, the migration model with the age and gender structure for the vole subpopulations; and construct the size change model for the vole populations based on the number of the vole subpopulations in the grid units of the unstructured grid, the mortality rates of the vole subpopulations, and the population size control equation.

The third model construction module is configured to solve for the energy input, the energy output, the migration energy consumption rate, the growth energy consumption rate, the pregnancy additional energy consumption rate, and the nurturing additional energy consumption rate of the voles within the grid units of the unstructured grid to obtain the solved results and construct, based on the solved results and the energy balance accounting equation, the energy storage change model of the voles at each time step.

The prediction module is configured to perform coupled computation on the quality evaluation model for the habitat of voles, the migration model for the vole subpopulations, the size change model for the vole populations, and the energy storage change model of the voles to obtain the numerical values of changes in the sizes of the vole populations in different grid units of the unstructured grid and predict the changes in the spatiotemporal distribution of the vole populations based on the numerical values of changes in the sizes of the vole populations.

Each module of the quantitative prediction device for the changes in the spatiotemporal distribution of the vole populations can be implemented entirely or partially through software, hardware, and/or combinations thereof. These modules may be embedded in or independent of a processor of a computer device in hardware form or stored in a memory of the computer device in software form so that the processor can call and execute operations corresponding to each module.

The disclosure further provides a computer device, including a memory and a processor. The memory is stored with a computer-executed instruction. The processor is configured to execute the computer-executed instruction stored in the memory, to thereby implement steps in embodiments of the quantitative prediction method for the changes in the spatiotemporal distribution of the vole populations. A specific implementation method can be found in the embodiments of the quantitative prediction method and will not be repeated here.

The disclosure further another provides a non-transitory computer-readable storage medium containing instructions, on which a computer program is stored. For example, a memory containing the instructions that can be executed by a processor of a computer device to perform the aforementioned quantitative prediction method. The non-transitory computer-readable storage medium may be, for example, read-only memory (ROM), random access memory (RAM), compact disc read-only memory (CD-ROM), magnetic tape, floppy disk, and optical data storage devices. When executed by the processor, the computer program is capable of implementing the steps in the embodiments of the quantitative prediction method for the changes in the spatiotemporal distribution of the vole populations. A specific implementation method can be found in the embodiments of the quantitative prediction method and will not be repeated here.

It should be noted that, the embodiments described above are used to enable those skilled in the art to have a more comprehensive understanding of the disclosure, rather than to limit the disclosure in any way. Therefore, although this specification and embodiments have provided detailed explanations of the disclosure, those skilled in the art should understand that modifications or equivalent substitutions can still be made to the disclosure. All technical solutions and improvements that do not depart from a spirit and scope of the disclosure shall fall within a scope of protection of the disclosure. Any reference numerals in the claims should not be regarded as limiting the claims involved.

What is claimed is:

1. A quantitative prediction method for changes in spatiotemporal distribution of vole populations, comprising the following steps:
determining a habitat of voles based on an activity range of the voles, and dividing the habitat of voles into an unstructured grid with triangular units as basis;
determining environmental change parameters of the habitat and a density of the voles as reference factors, and establishing a quality evaluation model for the habitat of voles using a geometric mean method;
grouping the voles in each of grid units of the unstructured grid according to ages and genders to obtain grouping results as vole subpopulations; constructing, based on the grouping results, a migration model with an age and gender structure for the vole subpopulations; and
constructing a size change model for the vole populations based on a number of the vole subpopulations in the grid units of the unstructured grid, mortality rates of the vole subpopulations, and a population size control equation;
solving for energy input, energy output, a migration energy consumption rate, a growth energy consumption rate, a pregnancy additional energy consumption rate, and a nurturing additional energy consumption rate of the voles within the grid units of the unstructured grid to obtain solved results; and constructing, based on the solved results and an energy balance accounting equation, an energy storage change model of the voles at each time step; and
performing coupled computation on the quality evaluation model for the habitat of voles, the migration model for the vole subpopulations, the size change model for the vole populations, and the energy storage change model of the voles to obtain numerical values of changes in sizes of the vole populations in different grid units of the unstructured grid, and predicting the changes in the spatiotemporal distribution of the vole populations based on the numerical values of the changes in the sizes of the vole populations.

2. The quantitative prediction method for the changes in the spatiotemporal distribution of the vole populations as claimed in claim 1, wherein quality of the habitat of voles is scored through the quality evaluation model for the habitat of voles according to the following formula:
$${Scor}_{ie}^{t} = {( {SSoilT}_{ie} \cdot {SPlantT}_{ie} \cdot {SLandU}_{ie}^{t} \cdot {SInund}_{ie}^{t} \cdot {ScDens}_{ie}^{t} \cdot {SRs}_{ie}^{t} \cdot {ST}_{ie}^{t} \cdot {SMois}_{ie}^{t} \cdot {SEnem}_{ie}^{t} )}^{\frac{1}{{n}^{′}}} where ,$$
$${Scor}_{ie}^{t}$$
represents a quality score of the habitat of voles at a time t in an ie-th grid unit of the unstructured grid, n′ represents a number of the reference factors, SSoilTᵢₑ represents a scoring for different soil types, SPlantTᵢₑ represents a scoring for a vegetation type
$$SLand {U}_{i e}^{t}$$
represents a scoring for land use,
$${SInund}_{i e}^{t}$$
represents a scoring for water inundation,
$${ScDens}_{i e}^{t}$$
represents a correlation scoring of the density of the voles,
$${SRs}_{i e}^{t}$$
represents a scoring for water depth of the habitat of voles,
$${ST}_{i e}^{t}$$
represents a scoring for a ground temperature of the habitat of voles,
$${SMois}_{i e}^{t}$$
represents a scoring for a soil moisture content, and
$${SEnem}_{i e}^{t}$$
represents a scoring for natural enemies in the habitat of voles.

3. The quantitative prediction method for the changes in the spatiotemporal distribution of the vole populations as claimed in claim 2, wherein formulas of the migration model for the vole subpopulations are expressed as follows:
$${X}_{ie , jgd , kag}^{n + 1} = {X}_{i e , jgd , kag}^{n} + ( {U}_{flow} + α \cdot {Um}_{i e , jgd , kag} \cdot sin θ + \frac{\partial {D}_{x}}{\partial x} ) Δ t + R \sqrt{6 \cdot {D}_{x}^{*} \cdot Δ t} ;$$
$${Y}_{ie , jgd , kag}^{n + 1} = {Y}_{ie , jgd , kag}^{n} + ( {V}_{flow} + α \cdot {U}_{Max , jgd , kag} \cdot cos θ + \frac{\partial {D}_{y}}{\partial y} ) Δ t + R \sqrt{6 \cdot {D}_{y}^{*} \cdot Δ t} ;$$
$$where , {X}_{ie , jgd , kag}^{n + 1} and {Y}_{ie , jgd , kag}^{n + 1}$$
represent grid coordinates of a specific position of a kag-th age and jgd-th gender group of the vole subpopulations at locations x and y at an (n+1)-th time step, respectively;
$${X}_{ie , jgd , kag}^{n} and {Y}_{ie , jgd , kag}^{n}$$
represent grid coordinates of the specific position of the kag-th age and jgd-th gender group of the vole subpopulations at the locations x and y at an n-th time step, respectively; U_{flow} and V_{flow} respectively represent water flow velocities in an x direction and a y direction; Um_{ie,jgd,kag} represents a maximum migration speed of the kag-th age and jgd-th gender group of the vole subpopulations; θ represents an included angle between a migration target grid unit and a source grid unit; α represents a speed correction coefficient; U_{Max,jgd,kag} represents a maximum migration speed, Dₓ and D_{y} represents turbulence coefficients of water flow in the x direction and the y direction, respectively; n represents a last time step, * represents an (n+½)-th time step, (n+1) represents a current time step, Δt represents a time step length, and R represents a random time constant.

4. The quantitative prediction method for the changes in the spatiotemporal distribution of the vole populations as claimed in claim 3, wherein when ages of the voles are larger than 20 days, a formula of the size change model for the vole populations is expressed as follows:
$${P}_{ie , jgd , kag}^{n + 1} = P s {k}_{ie , jgd , ka }^{n} \cdot ( 1 - D s {k}_{ie , jgd , kag} ) + {\sum }_{n m = 1}^{N um ( ie , jgd , kag )} Pm {v}_{ie , jgd , kag , nm} \cdot ( 1 - D m {v}_{ie , jgd , kag , nm} ) ;$$
$$where {P}_{i e , jgd , kag}^{n + 1}$$
$$Ps {k}_{ie , jgd , kag}^{n}$$
represents a number of voles in the kag-th age and jgd-th gender group of the vole subpopulations in the ie-th grid unit at the (n+1)-th time step, represents a number of voles in the kag-th age and jgd-th gender group of the vole subpopulations in the ie-th grid unit at the n-th time step, Pmv_{ie,jgd,kag,nm} represents a number of voles that migrate from all grid units adjacent to the ie-th grid unit to the kag-th age and jgd-th gender group of the vole subpopulations in the ie-th grid unit within a time step length from the n-th time step to the (n+1)-th time step, Num(ie,jgd,kag) represents a number of vole subpopulations that migrate to the ie-th grid unit having a same age and a same gender;
Dsk_{ie,jgd,kag} represents a mortality rate of the voles in the kag-th age and jgd-th gender group of the vole subpopulations in a static stack area of the ie-th grid unit, and Dmv_{ie,jgd,kag,nm} represents a mortality rate of the voles that migrate from all the grid units adjacent to the ie-th grid unit to the kag-th age and jgd-th gender group of the vole subpopulations in the migration target grid unit of the ie-th grid unit;
when the ages of the voles are smaller than 20 days and the number of the voles that migrate to the kag-th age and jgd-th gender group of the vole subpopulations in the ie-th grid unit is not taken into account, the formula for calculating the
$${P}_{i e , jgd , kag}^{n + 1}$$
is expressed as follows:
$${P}_{i e , jgd , kag}^{n + 1} = P s {k}_{ie , jgd , kag}^{n} \cdot ( 1 - D s {k}_{i e , jgd , kag} ) + Δ {P}_{igd}^{n + 1} \cdot {( 1 - {Dsk}_{i e , jgd , kag} )}^{Mod ( n , \frac{86400 \times 20}{Δ t} )} ;$$
$$Δ {P}_{i g d}^{n + 1} = {\sum }_{k a g = 1}^{Maxag} {P}_{1 , kag}^{n} \cdot {Rpreg}_{k a g} \cdot {B}_{kag} \cdot {R}_{jgd} ;$$
$$where {P}_{1 , kag}^{n}$$
represents a total number of mature female reed voles within the time step length from the n-th time step to the (n+1)-th time step, Rpreg_{kag} represents a pregnancy rate of the voles, B_{kag} represents an average litter size, and R_{jgd} represents a gender ratio of newborn voles;
when the ages of the voles are larger than 10 days but less than 20 days and the number of the voles that migrate to the kag-th age and jgd-th gender group of the vole subpopulations in the ie-th grid unit is not taken into account, the formula for calculating the
$${P}_{i e , jgd , kag}^{n + 1}$$
is expressed as follows:
$${P}_{i e , jgd , kag}^{n + 1} = P s {k}_{ie , jgd , kag}^{n} \cdot ( 1 - D s {k}_{ie , jgd , kag} ) .$$

5. The quantitative prediction method for the changes in the spatiotemporal distribution of the vole populations as claimed in claim 4, wherein a formula of the energy storage change model of the voles is expressed as follows:
$${E}_{sk , ie , jgd , kag}^{n + 1} = {E}_{sk , ie , jgd , kag}^{n} + {EIn}_{i e , jgd , kag} - {Mb}_{i e , jgd , kag} \cdot Δ t - {EMov}_{i e , jgd , kag} - EAd {d}_{ie , jgd , k a g} ;$$
$$where {E}_{sk , ie , jgd , kag}^{n + 1} and {E}_{sk , ie , jgd , kag}^{n}$$
represent energy values of the kag-th age and jgd-th gender group of the vole subpopulations living in the ie-th grid unit at the (n+1)-th time step and the n-th time step, respectively, EIn_{ie,jgd,kag} represents an energy supply obtained by the voles in the kag-th age and jgd-th gender group of the vole subpopulations living in the ie-th grid unit within the time step length Δt, Mb_{ie,jgd,kag} represents an energy consumption rate due to basal metabolism of the kag-th age and jgd-th gender group of the vole subpopulations living in the ie-th grid unit, EMov_{ie,jgd,kag} represents energy consumed by the kag-th age and jgd-th gender group of the vole subpopulations living in the ie-th grid unit during migration in the time step length Δt, and EAdd_{ie,jgd,kag} represents additional energy consumed by the kag-th age and jgd-th gender group of the vole subpopulations living in the ie-th grid unit in digging burrows and nurturing young within the time step length Δt, and Δt represents the time step length.

6. A quantitative prediction device for changes in spatiotemporal distribution of vole populations, comprising:
a habitat division module, configured to determine a habitat of voles based on an activity range of the voles and divide the habitat of voles into an unstructured grid with triangular units as basis;
a first model construction module, configured to determine environmental change parameters of the habitat of voles and a density of the voles as reference factors, calculate a spatiotemporal change result of each of the reference factors, and construct a quality evaluation model for the habitat of voles using a geometric mean method based on the spatiotemporal change result of each of the reference factors;
a second model construction module, configured to group the voles in each of grid units of the unstructured grid according to ages and genders to obtain grouping results as vole subpopulations, construct, based on the grouping results, a migration model with an age and gender structure for the vole subpopulations; and construct a size change model for the vole populations based on a number of the vole subpopulations in the grid units of the unstructured grid, mortality rates of the vole subpopulations, and a population size control equation;
a third model construction module, configured to solve for energy input, energy output, a migration energy consumption rate, a growth energy consumption rate, a pregnancy additional energy consumption rate, and a nurturing additional energy consumption rate of the voles within the grid units of the unstructured grid to obtain solved results and construct, based on the solved results and an energy balance accounting equation, an energy storage change model of the voles at each time step; and
a prediction module, configured to perform coupled computation on the quality evaluation model for the habitat of voles, the migration model for the vole subpopulations, the size change model for the vole populations, and the energy storage change model of the voles to obtain numerical values of changes in sizes of the vole populations in different grid units of the unstructured grid and predict the changes in the spatiotemporal distribution of the vole populations based on the numerical values of changes in the sizes of vole populations.

7. A computer device, comprising a memory and a processor, wherein the memory is stored with a computer-executed instruction, and the processor is configured to execute the computer-executed instruction stored in the memory, to thereby implement steps of the quantitative prediction method for the changes in the spatiotemporal distribution of the vole populations as claimed in claim 1.

8. A computer-readable storage medium, configured to store a computer-executed instruction, and the computer-executed instruction, when executed by a processor, is used to implement steps of the quantitative prediction method for the changes in the spatiotemporal distribution of the vole populations as claimed in claim 1.
